(19) United States
(12) Patent Application Publication
(10) Pub. No.: US 2026/0001321 A1
(43) Pub. Date: Jan. 1, 2026

(54) METHOD OF DRIVING LIQUID EJECTING APPARATUS, AND LIQUID EJECTING APPARATUS

(71) Applicant: SEIKO EPSON CORPORATION, Tokyo (JP)

(72) Inventor: Yuki WATANABE, MATSUMOTO-SHI (JP)

(21) Appl. No.: 19/246,855

(22) Filed: Jun. 24, 2025

(30) Foreign Application Priority Data
Jun. 27, 2024 (JP) 2024-103802

(51) Int. Cl. B41J 2/045; B41J 2/02; B41J 2/03

(52) U.S. Cl. CPC B41J 2/04588; B41J 2/03; B41J 2/04541; B41J 2/04573; B41J 2/04586; B41J 2002/022

(57) ABSTRACT

A liquid ejecting apparatus includes an ejection section that is configured to eject a droplet from a nozzle communicating with a pressure chamber by driving a drive element according to a supplied drive signal The drive signal includes a at least one ejection pulse including an ejection waveform element that changes an electrical potential to be ejected a droplet from the nozzle, and a residual vibration suppression element that changes an electrical potential to reduce the change in the pressure of the liquid in the pressure chamber, the change in the pressure remaining after the ejection of the droplet according to a natural vibration period of the ejection section. A weight of droplets to be continuously ejected from the nozzle when the drive signal is supplied to the drive element over a period corresponding to two or more drive periods is corrected by adjusting the residual vibration suppression element.

The present application is based on, and claims priority from JP Application Serial Number 2024-103802, filed Jun. 27, 2024, the disclosure of which is hereby incorporated by reference herein in its entirety.

### BACKGROUND

### 1. Technical Field

The present invention relates to a method of driving a liquid ejecting apparatus and a liquid ejecting apparatus.

### 2. Related Art

In the related art, there is provided a liquid ejecting apparatus including a nozzle from which a droplet is ejected, a pressure chamber communicating with the nozzle, and a drive element that is driven to change pressure applied to liquid in a pressure chamber according to the supplied drive signal. For example, JP-A-2010-184380 discloses that the difference between the lowest electrical potential and the highest electrical potential in a drive signal is adjusted in order to correct the amount of a droplet to be ejected from a nozzle.

However, in the related art described above, even when the difference between the electrical potentials in the drive signal is adjusted, it is difficult to correct the amount of a droplet to be ejected to a desired amount in some cases.

### SUMMARY

According to an aspect of the present disclosure, there is provided a method of driving a liquid ejecting apparatus including an ejection section including a nozzle from which a droplet is ejected, a pressure chamber communicating with the nozzle, and a drive element that is driven to change pressure applied to the liquid in the pressure chamber according to a supplied drive signal, and a drive signal generating circuit that generates the drive signal. The drive signal includes at least one ejection pulse in a drive period. The at least one ejection pulse includes an ejection waveform element that changes the pressure applied to the liquid in the pressure chamber such that a droplet is ejected from the nozzle, and a residual vibration suppression element that reduces the change in the pressure applied to the liquid in the pressure chamber, the change in the pressure remaining after the ejection of the droplet from the nozzle according to a natural vibration period of the ejection section. The method includes adjusting the residual vibration suppression element of the at least one ejection pulse to correct a weight of droplets that are continuously ejected from the nozzle when the drive signal is supplied to the drive element over a period corresponding to two or more drive periods.

According to another aspect of the present disclosure, there is provided a liquid ejecting apparatus including an ejection section including a nozzle from which a droplet is ejected, a pressure chamber communicating with the nozzle, and a drive element that is driven to change pressure applied to the liquid in the pressure chamber according to a supplied drive signal, and a drive signal generating circuit that generates the drive signal. The drive signal includes at least one ejection pulse in a drive period. The at least one ejection pulse includes an ejection waveform element that changes the pressure applied to the liquid in the pressure chamber such that a droplet is ejected from the nozzle, and a residual vibration suppression element that reduces the change in the pressure applied to the liquid in the pressure chamber, the change in the pressure remaining after the ejection of the droplet from the nozzle according to a natural vibration period of the ejection section. The liquid ejecting apparatus adjusts the residual vibration suppression element of the at least one ejection pulse to correct a weight of droplets that are continuously ejected from the nozzle when the drive signal is supplied to the drive element over a period corresponding to two or more drive periods.

### BRIEF DESCRIPTION OF THE DRAWINGS

FIG. 1 is a schematic diagram illustrating an example of a configuration of a liquid ejecting apparatus according to a first embodiment.

FIG. 2 is a diagram illustrating an electrical configuration of the liquid ejecting apparatus according to the first embodiment.

FIG. 3 is a bottom view of a liquid ejecting head illustrated in FIG. 2.

FIG. 4 is a sectional view illustrating a portion of each of head chips illustrated in FIG. 3.

FIG. 5 is a diagram illustrating a mode for supplying a drive signal.

FIG. 6 is a diagram illustrating the mode for supplying the drive signal.

FIG. 7 is a diagram illustrating a switching circuit.

FIG. 8 is a diagram illustrating a drive signal for generating a supply signal to be supplied to a head chip.

FIG. 9 is a diagram illustrating a relationship between a drive period and an amount of liquid to be ejected.

FIG. 10 is a diagram illustrating a relationship between an electrical potential difference and an amount of liquid to be ejected for each drive frequency in a method of adjusting the electrical potential difference.

FIG. 11 is a diagram illustrating a drive frequency characteristic.

FIG. 12 is a diagram illustrating the reason why the amount of change in the amount of liquid to be ejected varies depending on the level of a drive frequency.

FIG. 13 is a diagram illustrating a drive frequency characteristic when a residual vibration suppression element is adjusted.

FIG. 14 is a flowchart illustrating an example of a process of correcting an amount of liquid to be ejected.

FIG. 15 is a flowchart illustrating an example of a process of adjusting a residual vibration suppression element.

FIG. 16 is a diagram illustrating a relationship between an adjustment time interval and an amount of liquid to be ejected.

FIG. 17 is a diagram illustrating an example of adjustment of a residual vibration suppression element of a drive signal.

FIG. 18 is a diagram illustrating an example of adjustment of a residual vibration suppression element of a drive signal.

FIG. 19 is a diagram illustrating a drive signal in a second embodiment.

FIG. 20 is a diagram illustrating a drive signal in a fifth modification.

FIG. 21 is a diagram illustrating a drive signal in a sixth modification.

### DESCRIPTION OF EMBODIMENTS

Hereinafter, preferred embodiments according to the present disclosure will be described with reference to the accompanying drawings. In the drawings, the size and scale of each section are appropriately different from the actual size and scale, and some sections are schematically illustrated to facilitate understanding. The scope of the present disclosure is not limited to these embodiments unless otherwise stated to limit the disclosure in the following description.

In the following description, an X axis, a Y axis, and a Z axis that intersect each other are appropriately used. In the following description, one direction along the X axis is an X1 direction, and a direction opposite to the X1 direction is an X2 direction. Similarly, directions opposite to each other along the Y axis are a Y1 direction and a Y2 direction. Directions opposite to each other along the Z axis are a Z1 direction and a Z2 direction. Typically, the Z axis is a vertical axis, and the Z2 direction corresponds to a downward direction in a vertical direction. However, the Z axis may be rather than the vertical axis. The X axis, the Y axis, and the Z axis are typically orthogonal to each other, but are not limited thereto. For example, the X axis, the Y axis, and the Z axis may intersect each other at an angle in a range of 800 to 100°. Further, in the present specification, a term “equal” does not only indicate strictly equal but also has a meaning including a manufacturing error and an assembly error.

### A. First Embodiment

### A1: Overall Configuration of Liquid Ejecting Apparatus 100

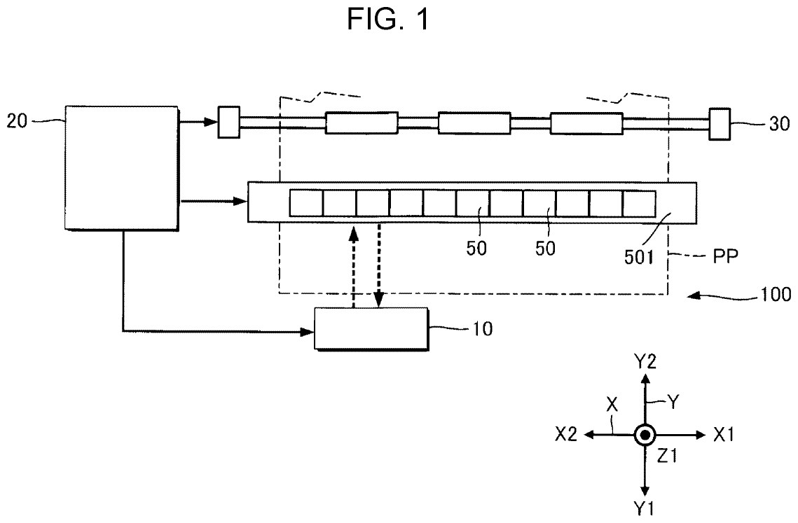

FIG. 1 is a schematic diagram illustrating an example of a configuration of a liquid ejecting apparatus 100 according to a first embodiment. The liquid ejecting apparatus 100 is an ink jet printing apparatus that ejects liquid such as ink as a droplet onto a medium PP. The medium PP is, for example, a printing sheet. The medium PP is not limited to the printing sheet, and may be a printing object made of any material such as a resin film or fabric.

As illustrated in FIG. 1, the liquid ejecting apparatus 100 includes a liquid container 10, a control unit 20, a transport mechanism 30, and liquid ejecting heads 50.

The liquid container 10 stores liquid. As a specific aspect of the liquid container 10, for example, a cartridge that is attachable to and detachable from the liquid ejecting apparatus 100, a bag-shaped liquid pack that is formed of a flexible film, and a liquid tank that can be refilled with liquid are exemplified. A type of the liquid stored in the liquid container 10 is optional.

The control unit 20 controls an operation of each of sections of the liquid ejecting apparatus 100. The control unit 20 includes, for example, one or more processing circuits, such as a central processing unit (CPU) or a field programmable gate array (FPGA), and one or more storage circuits, such as a semiconductor memory.

The transport mechanism 30 transports the medium PP in the Y1 direction under control by the control unit 20. The transport mechanism 30 includes, for example, an elongated transport roller extending along the X axis and a motor that rotates the transport roller. The transport mechanism 30 is not limited to the configuration in which the transport roller is used. For example, the transport mechanism 30 may have a configuration in which a drum or an endless belt that transports the medium PP in a state where the medium PP is attracted to an outer circumferential surface of the drum or the endless belt by an electrostatic force or the like is used.

The plurality of liquid ejecting heads 50 are mounted in a carriage 501. The plurality of liquid ejecting heads 50 are provided so as to be distributed over the entire range of the medium PP in the direction along the X axis. Each of the liquid ejecting heads 50 ejects the liquid supplied from the liquid container 10 onto the medium PP from each of a plurality of nozzles N under control by the control unit 20 based on image data Img. The ejection is performed in parallel with the transport of the medium PP by the transport mechanism 30, and thus an image corresponding to the image data Img is formed by droplets of the liquid on a front surface of the medium PP.

### A2: Electrical Configuration of Liquid Ejecting Apparatus 100

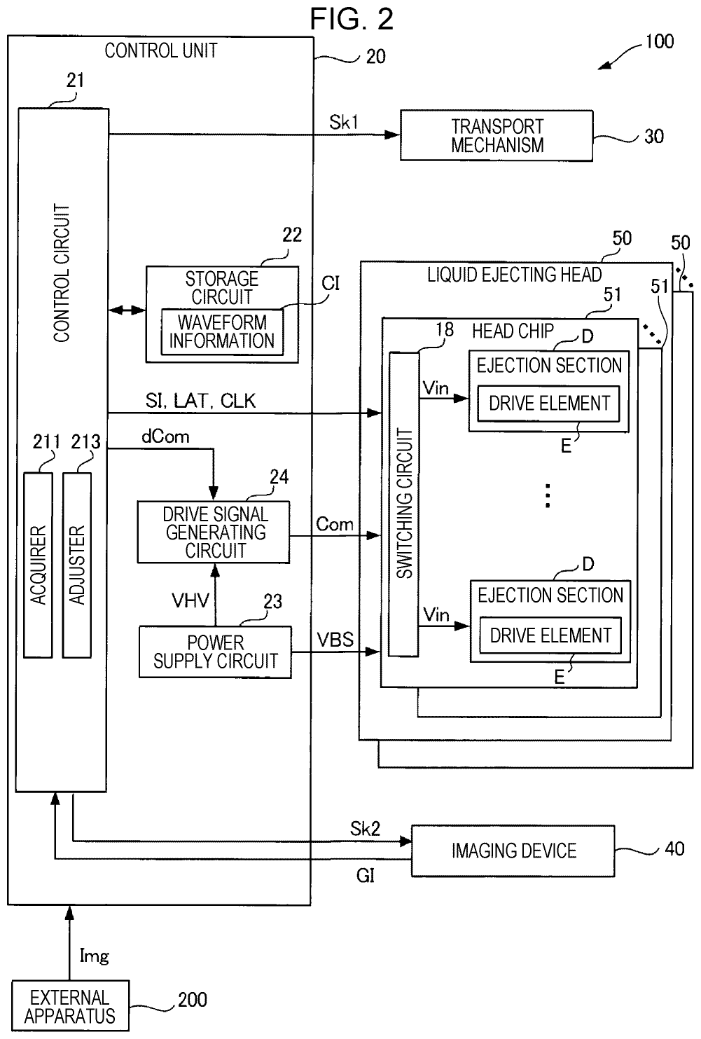

FIG. 2 is a diagram illustrating an electrical configuration of the liquid ejecting apparatus 100 according to the first embodiment. As illustrated in FIG. 2, each of the liquid ejecting heads 50 includes a plurality of head chips 51. In the present embodiment, six head chips 51 are provided as the plurality of head chips 51 in each of the liquid ejecting heads 50.

Each of the head chips 51 includes a switching circuit 18 and M ejection sections D. Hereinafter, when the number of ejection sections D included in each of the head chips 51 is set to M, in order to distinguish each of the M ejection sections D, the ejection section D may be denoted as an ejection section D[m] using a suffix [m]. In this case, M is an integer greater than or equal to 1, and m is an integer greater than or equal to 1 and less than or equal to M. In addition, in the liquid ejecting apparatus 100, the suffix [m] may also be used for elements included in the ejection section D[m].

The switching circuit 18 switches whether or not to supply a drive signal Com output from the control unit 20 as a supply signal Vin to each of the plurality of ejection sections D under control by the control unit 20. In the present embodiment, each of the head chips 51 includes the switching circuit 18, but each of the head chips 51 may not include the switching circuit 18.

The control unit 20 includes a control circuit 21, a storage circuit 22, a power supply circuit 23, and a drive signal generating circuit 24.

The control circuit 21 has a function of controlling an operation of each of the sections of the liquid ejecting apparatus 100 and a function of processing various data. The control circuit 21 includes, for example, a processor such as one or more central processing units (CPUs). The control circuit 21 may include a programmable logic device such as a field-programmable gate array (FPGA) instead of the one or more CPUs or in addition to the one or more CPUs. In a case where the control circuit 21 includes a plurality of processors, the plurality of processors may be mounted on different substrates or the like.

In addition, the control circuit 21 generates, as signals for controlling the operation of each of the sections of the liquid ejecting apparatus 100, a control signal Sk1, a print data signal SI, a waveform specifying signal dCom, a latch signal LAT, and a clock signal CLK by executing a program stored in the storage circuit 22.

The control signal Sk1 is a signal for controlling the driving of the transport mechanism 30. The print data signal SI is a digital signal for specifying operation states of the drive elements E. The latch signal LAT is used together with the print data signal SI, and is a timing signal that defines a timing at which the liquid is ejected from each of the nozzles N of the head chips 51.

The control circuit 21 functions as an acquirer 211 and an adjuster 213 by reading a program stored in the storage circuit 22 and executing the read program. The acquirer 211 and the adjuster 213 will be described later.

The storage circuit 22 stores various programs to be executed by the control circuit 21, various data such as the image data Img to be processed by the control circuit 21, and waveform information CI for generating the waveform specifying signal dCom. The storage circuit 22 includes, for example, one or both of semiconductor memories that are a volatile memory such as a random access memory (RAM) and a non-volatile memory such as a read only memory (ROM), an electrically erasable programmable read-only memory (EEPROM), or a programmable ROM (PROM). The image data Img is supplied from an external apparatus 200 such as a personal computer or a digital camera. The storage circuit 22 may be configured as a portion of the control circuit 21.

The power supply circuit 23 receives power supplied from a commercial power supply (not illustrated) and generates various predetermined electrical potentials. The generated various electrical potentials are appropriately supplied to the sections of the liquid ejecting apparatus 100. For example, the power supply circuit 23 generates a power supply electrical potential VHV and an offset electrical potential VBS. The offset electrical potential VBS is supplied to the liquid ejecting heads 50. The power supply electrical potential VHV is supplied to the drive signal generating circuit 24.

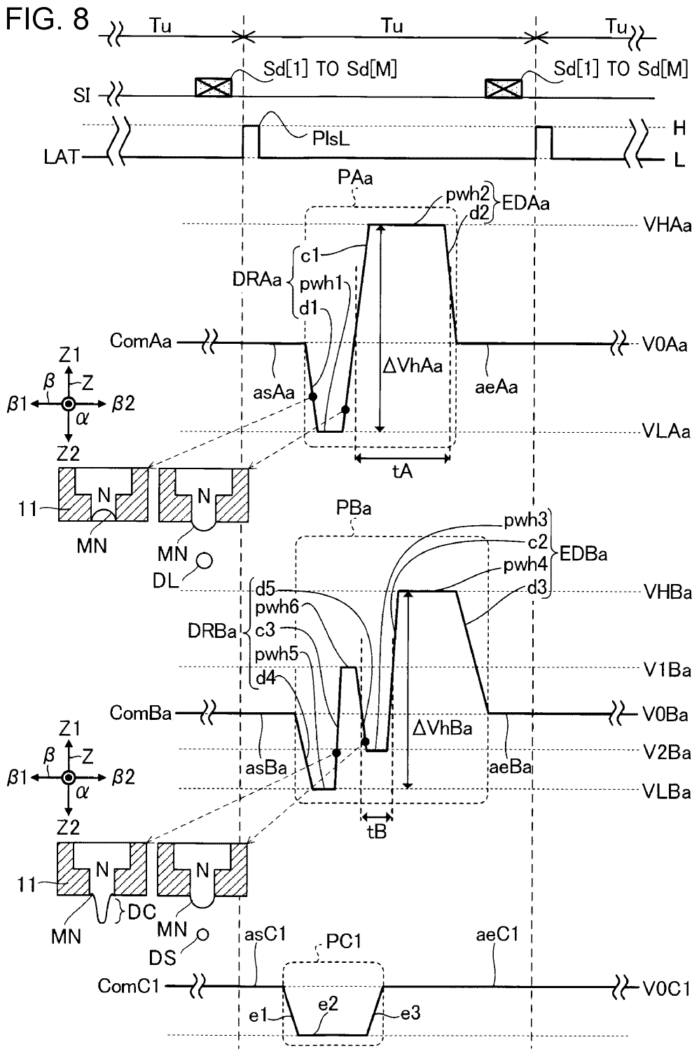

The drive signal generating circuit 24 repeatedly generates a drive signal Com for driving each of the drive elements E included in each of the ejection sections D. Specifically, the drive signal generating circuit 24 includes, for example, a digital-to-analog (DA) conversion circuit and an amplifier circuit. In the drive signal generating circuit 24, the DA conversion circuit converts the waveform specifying signal dCom from the control circuit 21 from a digital signal to an analog signal. The amplifier circuit generates the drive signal Com by amplifying the analog signal using the power supply electrical potential VHV from the power supply circuit 23. A signal having a waveform that is included in a waveform included in the drive signal Com and is actually supplied to the drive elements E is the above-described supply signal Vin. The waveform specifying signal dCom is a digital signal for defining the waveform of the drive signal Com. The control circuit 21 generates the waveform specifying signal dCom based on the waveform information CI. Details of the waveform information CI will be described later with reference to FIG. 8.

In the present embodiment, it is assumed that the drive signal Com includes a drive signal ComAa, a drive signal ComAb, a drive signal ComAc, a drive signal ComBa, a drive signal ComBb, a drive signal ComBc, a drive signal ComC1, and a drive signal ComC2. For example, the drive signal generating circuit 24 causes eight independent circuits included in the drive signal generating circuit 24 to generate the drive signal ComAa, the drive signal ComAb, the drive signal ComAc, the drive signal ComBa, the drive signal ComBb, the drive signal ComBc, the drive signal ComC1, and the drive signal ComC2. Hereinafter, each of the drive signal ComAa, the drive signal ComAb, and the drive signal ComAc may be referred to as a drive signal ComA without being distinguished from each other. In addition, each of the drive signal ComBa, the drive signal ComBb, and the drive signal ComBc may be referred to as a drive signal ComB without being distinguished from each other. In addition, each of the drive signal ComC1 and the drive signal ComC2 may be referred to as a drive signal ComC without being distinguished from each other.

The drive signal ComA is a signal for causing liquid in an amount corresponding to a large dot to be ejected from the ejection section D. The drive signal ComB is a signal for causing liquid in an amount corresponding to a small dot to be ejected from the ejection section D. The drive signal ComC is a signal for driving the drive elements E such that liquid is not ejected. More specifically, the drive signal ComC is a signal for minutely vibrating the surface of the liquid in each of the nozzles N by driving the drive elements E such that the liquid is not ejected in order to prevent thickening of the liquid in each of the nozzles N. Hereinafter, the surface of liquid in each of the nozzles N may be referred to as a “meniscus”.

In addition, the liquid ejecting apparatus 100 includes an imaging device 40 in order to measure the amount of liquid ejected from each of the ejection sections D. The imaging device 40 images flying liquid ejected from each of the ejection sections D. Specifically, the imaging device 40 includes, for example, an imaging optical system and an imaging element. The imaging optical system is an optical system including at least one imaging lens, and may include various optical elements such as a prism, or may include a zoom lens, a focus lens, or the like. The imaging element is, for example, a CCD image sensor or a CMOS image sensor. CCD is an abbreviation for Charge Coupled Device. CMOS is an abbreviation for Complementary Metal-Oxide-Semiconductor.

The control circuit 21 transmits an imaging instruction Sk2 to the imaging device 40. Upon receiving the imaging instruction Sk2, the imaging device 40 transmits, to the control circuit 21, image information GI indicating an image in which the flying liquid appears. The control circuit 21 acquires the weight of flying droplets based on the image information GI.

The method of measuring the amount of liquid ejected is not limited to the above-described method. For example, the liquid ejecting apparatus 100 can also measure the amount of liquid ejected from each of the ejection sections D by using a device that images the liquid that has landed on the medium PP or the like, or by using an electronic balance that measures the mass of the liquid ejected from each of the ejection sections D, without using the imaging device 40.

### A3: Arrangement of Plurality of Head Chips 51

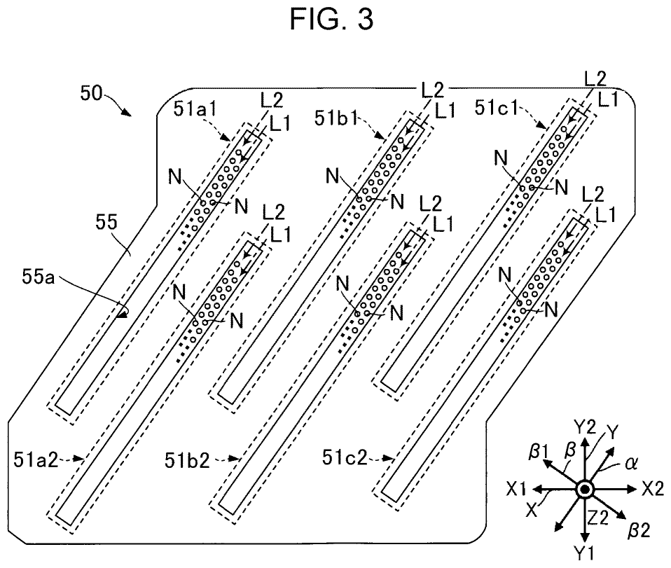

FIG. 3 is a bottom view of the liquid ejecting head 50 illustrated in FIG. 2. As described above, the liquid ejecting head 50 includes the six head chips 51 separated from each other. The six head chips 51 are fixed to a fixing plate 55. In FIG. 3, since the liquid ejecting head 50 is viewed from the Z2 direction to the Z1 direction, the head chips 51 cannot be seen, but the six head chips 51 are indicated by broken lines for the sake of simplicity. The six head chips 51 are partially exposed due to openings 55a disposed in the fixing plate 55. Each of the head chips 51 has an elongated shape extending along an a axis intersecting the X axis and the Y axis as viewed in the Z1 direction.

In the embodiment, among the six head chips 51, the head chip 51 located at an end portion in the X1 direction and an end portion in the Y2 direction may be referred to as a head chip 51a1. Similarly, the head chip 51 located at the end portion in the X1 direction and an end portion in the Y1 direction may be referred to as a head chip 51a2. The head chip 51 located at an end portion in the X2 direction and the end portion in the Y2 direction may be referred to as a head chip 51c1. The head chip 51 located at the end portion in the X2 direction and the end portion in the Y1 direction may be referred to as a head chip 51c2. The head chip 51 located between the head chip 51a1 and the head chip 51c1 may be referred to as a head chip 51bi. The head chip 51 located between the head chip 51a2 and the head chip 51c2 may be referred to as a head chip 51b2.

Each of the six head chips 51 have a total of M nozzles N included in the M ejection sections D. The M nozzles N are exposed due to the opening 55a. The M nozzles N are divided into a nozzle row L1 and a nozzle row L2 such that each of the M nozzles N is included in any one of the nozzle row L1 and the nozzle row L2. Hereinafter, the nozzle row L1 and the nozzle row L2 may be referred to as nozzle rows Ln without being distinguished from each other. Each of the nozzle rows Ln intersects the X axis and the Y axis and is a set of a plurality of nozzles N arranged in a straight line. The nozzle rows Ln extend along the a-axis.

The planar shape of each of the plurality of nozzles N is, for example, a circular shape, and the plurality of nozzles N are formed to have the same opening area. The nozzles N belonging to each of the nozzle rows Ln are arranged at equal intervals along a R axis orthogonal to the a axis.

### A4: Configuration of Portion of Each Head Chip 51

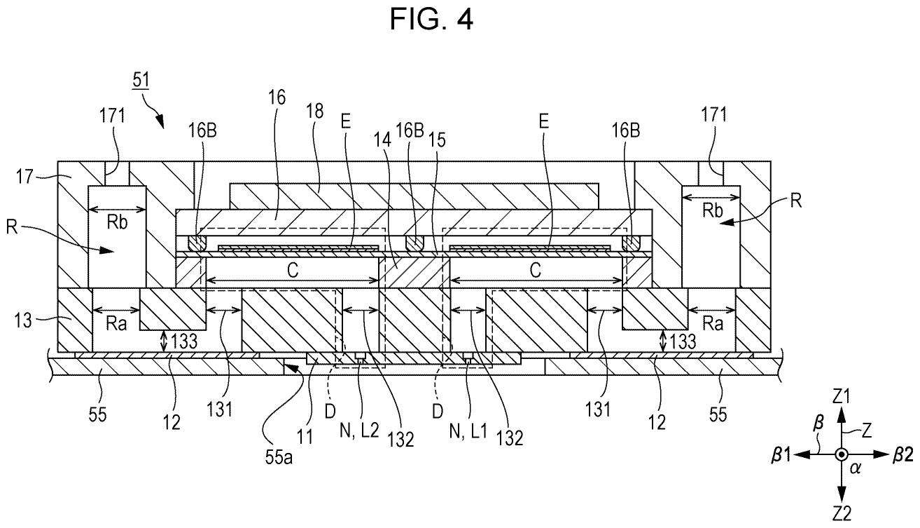

FIG. 4 is a cross-sectional view illustrating a portion of each of the head chips 51 illustrated in FIG. 3. FIG. 4 also illustrates a portion of the fixing plate 55. As illustrated in FIG. 4, each of the head chips 51 includes a nozzle plate 11, a vibration absorbing body 12, a flow path substrate 13, a pressure chamber substrate 14, a vibration plate 15, a wiring substrate 16, a housing portion 17, and the switching circuit 18. Each of the nozzle plate 11, the vibration absorbing body 12, the flow path substrate 13, the pressure chamber substrate 14, the vibration plate 15, the wiring substrate 16, and the housing portion 17 is a plate-like member elongated in the direction along the a-axis. The nozzle plate 11, the flow path substrate 13, the pressure chamber substrate 14, the vibration plate 15, and the wiring substrate 16 are arranged in this order in the Z1 direction.

The nozzle plate 11 is a plate-shaped member in which the plurality of nozzles N are formed. Each of the plurality of nozzles N is a through-hole through which the liquid passes. The liquid is ejected from the nozzles N by the vibration of the vibration plate 15. The nozzle plate 11 is bonded to the flow path substrate 13 by, for example, an adhesive.

A flow path for supplying the liquid to the plurality of nozzles N is formed in the flow path substrate 13. Specifically, a space Ra, a plurality of supply flow paths 131, a plurality of communication flow paths 132, and a supply liquid chamber 133 are formed in the flow path substrate 13. The space Ra is an elongated opening extending in the direction along the a axis in plan view as viewed in the direction along the Z axis. Each of the supply flow paths 131 and each of the communication flow paths 132 are through-holes formed for each of the nozzles N. The supply liquid chamber 133 is an elongated space extending in the direction along the a axis over the plurality of nozzles N, and the space Ra communicates with the plurality of supply flow paths 131 via the supply liquid chamber 133. Each of the plurality of communication flow paths 132 overlaps a nozzle N corresponding to the communication flow path 132 in plan view. The pressure chamber substrate 14 is bonded to the flow path substrate 13 by, for example, an adhesive.

The pressure chamber substrate 14 is provided with a plurality of pressure chambers C. Each of the pressure chambers C is formed for a respective one of the nozzles N and is an elongated space extending in the direction along the R axis in plan view. The plurality of pressure chambers C are arranged in the direction along the a axis. The pressure chambers C are spaces located between the flow path substrate 13 and the vibration plate 15. The pressure chambers C communicate with the nozzles N via the communication flow paths 132 and communicate with the space Ra via the supply flow paths 131 and the supply liquid chamber 133.

Each of the nozzle plate 11, the flow path substrate 13, and the pressure chamber substrate 14 is manufactured by processing a silicon single crystal substrate using, for example, dry etching, wet etching, or the like. However, other known methods may be appropriately used to manufacture the nozzle plate 11, the flow path substrate 13, and the pressure chamber substrate 14.

The vibration plate 15 is disposed on a surface of the pressure chamber substrate 14 facing the Z1 direction. The vibration plate 15 is a plate-like member that can elastically vibrate.

The plurality of drive elements E corresponding to the nozzles N are disposed on a surface of the vibration plate 15 facing the Z1 direction. Each of the drive elements E has an elongated shape extending in the direction along the R axis in plan view. The plurality of drive elements E correspond to the plurality of pressure chambers C and are arranged in the direction along the a axis. The drive elements E are driven to change the volumes of the pressure chambers C in accordance with the supply signal Vin generated from the drive signal Com. That is, each of the drive elements E is deformed by the application of a voltage. When the vibration plate 15 vibrates in conjunction with the deformation, the pressure in the pressure chambers C changes and thus the liquid is ejected from the nozzles N.

The housing portion 17 is a case for storing the liquid to be supplied to the plurality of pressure chambers C. As illustrated in FIG. 4, a space Rb is formed in the housing portion 17. The space Rb of the housing portion 17 and the space Ra of the flow path substrate 13 communicate with each other. A space formed by the space Ra and the space Rb functions as a liquid storage chamber R that is a reservoir for storing the liquid to be supplied to the plurality of pressure chambers C. The liquid is supplied to the liquid storage chamber R through an inlet 171 formed in the housing portion 17. The liquid in the liquid storage chamber R is supplied to the pressure chambers C through the supply liquid chamber 133 and each of the supply flow paths 131.

The vibration absorbing body 12 is a flexible film that forms a wall surface of the liquid storage chamber R. The vibration absorbing body 12 is a compliance substrate that reduces a change in pressure applied to the liquid in the liquid storage chamber R.

The wiring substrate 16 is a plate-like member on which wiring for electrically coupling the switching circuit 18 and the plurality of drive elements E is formed. The wiring substrate 16 is, for example, a rigid substrate. On the wiring substrate 16, wiring is formed which electrically couples the switching circuit 18 mounted on a surface of the wiring substrate 16 facing the Z1 direction and a plurality of bumps 16B that are disposed on a surface of the wiring substrate 16 facing the Z2 direction and are necessary for driving the drive elements E. The switching circuit 18 includes an integrated circuit (IC) chip that outputs the supply signal Vin based on the drive signal Com for driving each of the drive elements E, and outputs the offset electrical potential VBS. A flexible wiring substrate (not illustrated) coupled to the control unit 20 is coupled to the wiring substrate 16.

The wiring substrate 16 may be, for example, a flexible substrate such as a flexible flat cable (FFC) or may be a flexible printed circuit (FPC), a chip on film (COF), or the like in which the switching circuit 18 is mounted on the substrate.

As illustrated in FIG. 4, each of the ejection sections D includes one drive element E, one pressure chamber C, and one nozzle N. As is understood from FIG. 4 and the like, the pressure chamber C and the drive element E included in each of the ejection sections D are configured such that the drive element E overlaps a part or all of the pressure chamber C in plan view as viewed in the Z2 direction. When the drive signal Com is supplied to the drive element E based on the print data signal SI, the drive element E is driven by the drive signal Com to cause the ejection section D to eject the ink in the pressure chamber C from the nozzle N.

The configuration of each of the head chips 51 is not limited to the example illustrated in FIG. 4. Each of the head chips 51 may have, for example, a circulation flow path for circulating the liquid.

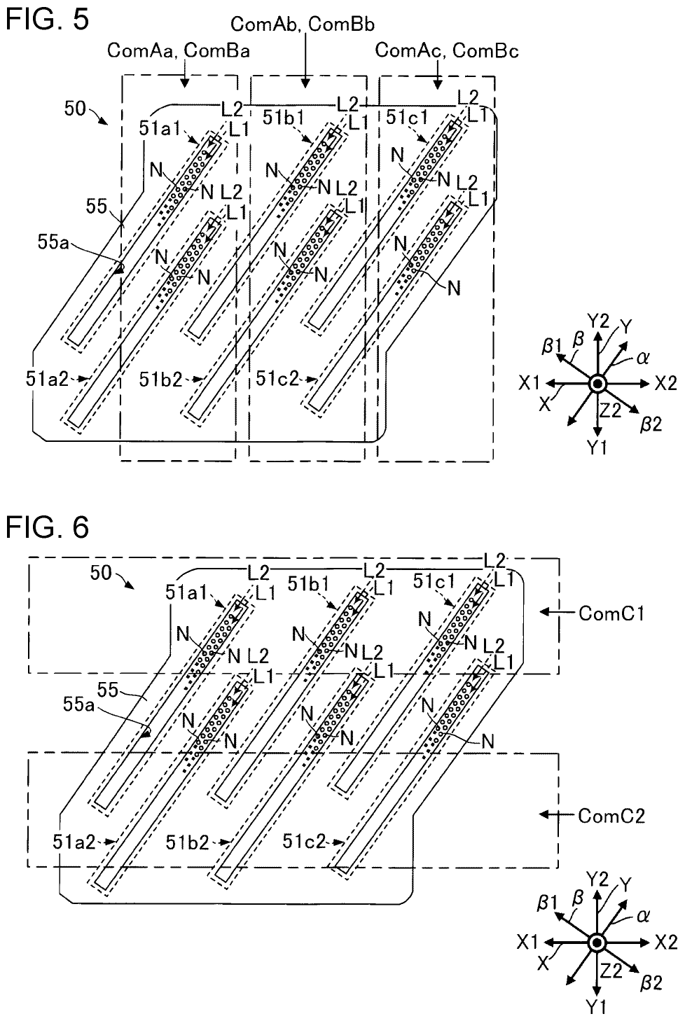

FIGS. 5 and 6 are diagrams illustrating a mode for supplying the drive signal Com. As illustrated in FIG. 5, the same drive signal Com is supplied to the head chips 51 arranged in the Y1 direction that is the transport direction of the medium PP as the drive signal Com involved in the ejection of the liquid. Specifically, the drive signal ComAa and the drive signal ComBa are supplied to the head chip 51a1 and the head chip 51a2. The drive signal ComAb and the drive signal ComBb are supplied to the head chip 51b1 and the head chip 51b2. The drive signal ComAc and the drive signal ComBc are supplied to the head chip 51c1 and the head chip 51c2.

In the present embodiment, as illustrated in FIG. 6, the drive signal ComC for not ejecting the liquid from the nozzles N is common to the head chips 51 arranged in the X1 direction intersecting the transport direction of the medium PP. Specifically, the same drive signal ComC1 is supplied to the head chip 51a1, the head chip 51b1, and the head chip 51c1. Further, the same drive signal ComC2 is supplied to the head chip 51a2, the head chip 51b2, and the head chip 51c2.

However, the mode for supplying the drive signal Com is not limited to the mode illustrated in FIGS. 5 and 6. For example, the drive signal generating circuit 24 may supply the same drive signal ComC to the six head chips 51. In the following description, it is assumed that the mode for supplying the drive signal Com is the mode illustrated in FIGS. 5 and 6.

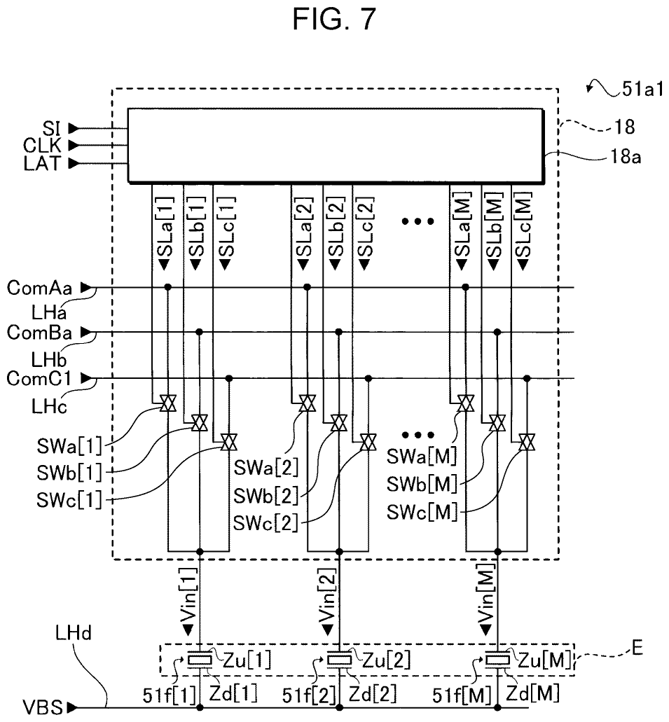

As is understood from the above description, three drive signals Com may be supplied to each of the head chips 51. An aspect in which the three drive signals Com are switched and supplied to each of the head chips 51 will be described with reference to FIG. 7.

### A5: Driving of Drive Elements E

FIG. 7 is a diagram illustrating the switching circuit 18. FIG. 7 illustrates the switching circuit 18 of the head chip 51a1. The drive elements E are driven by the supply signal Vin from the switching circuit 18. The switching circuit 18 will be described below with reference to FIG. 7.

As illustrated in FIG. 7, wiring LHa, wiring LHb, and wiring LHc are coupled to the switching circuit 18. The wiring LHa is a signal line through which the drive signal ComAa is transmitted. The wiring LHb is a signal line through which the drive signal ComBa is transmitted. The wiring LHc is a signal line through which the drive signal ComC1 is transmitted. FIG. 7 illustrates either first electrodes and second electrodes of the drive elements E as electrodes Zd[m] and illustrates the other electrodes as electrodes Zu[m]. Wiring LHd is coupled to the electrodes Zd[m]. The wiring LHd is a power supply line through which the offset electrical potential VBS is supplied.

The switching circuit 18 includes switches SWa[1] to SWa[M] that are M switches SWa, switches SWb[1] to SWb[M] that are M switches SWb, switches SWc[1] to SWc[M] that are M switches SWb, and a coupling state specifying circuit 18a that specifies coupling states of these switches.

Regarding each of integers m from 1 to M, the switch SWa[m] switches between conduction and non-conduction between the wiring LHa for transmitting the drive signal ComAa and the electrode Zu[m] of the drive element E[m]. Regarding each of the integers m from 1 to M, the switch SWb[m] switches between conduction and non-conduction between the wiring LHb for transmitting the drive signal ComBa and the electrode Zu[m] of the drive element E[m]. Regarding each of the integers m from 1 to M, the switch SWc[m] switches between conduction and non-conduction between the wiring LHc for transmitting the drive signal ComC1 and the electrode Zu[m] of the drive element E[m]. Each of these switches is, for example, a transmission gate.

The coupling state specifying circuit 18a generates coupling state specifying signals SLa[1] to SLa[M] for specifying whether to turn on or off the switches SWa[1] to SWa[M], coupling state specifying signals SLb[1] to SLb[M] for specifying whether to turn on or off the switches SWb[1] to SWb[M], and coupling state specifying signals SLc[1] to SLc[M] for specifying whether to turn on or off the switches SWc[1] to SWc[M], based on the clock signal CLK, the print data signal SI, and the latch signal LAT supplied from the control circuit 21.

For example, although not illustrated, the coupling state specifying circuit 18a includes a plurality of transfer circuits, a plurality of latch circuits, and a plurality of decoders such that sets of the plurality of transfer circuits, the plurality of latch circuits, and the plurality of decoders correspond to the drive elements E[1] to E[M] in a one-to-one manner. The print data signal SI is supplied to the transfer circuits among these circuits. In this case, the print data signal SI includes individual specifying signals Sd for the respective drive elements E, the individual specifying signals Sd are serially supplied, and for example, the individual specifying signals Sd are sequentially transferred to the plurality of transfer circuits in synchronization with the clock signal CLK. Further, the latch circuits latch, based on the latch signal LAT, the individual specifying signals Sd supplied to the transfer circuits. In addition, the decoders generate, based on the individual specifying signals Sd and the latch signal LAT, the coupling state specifying signals SLa[m], the coupling state specifying signals SLb[m], and the coupling state specifying signals SLc[m] for the switches SWa[m], the switches SWb[m], and the switches SWc[m].

Regarding each of the integers m from 1 to M, the switch SWa[m] is turned on and off in accordance with the coupling state specifying signal SLa[m]. For example, the switch SWa[m] is in an ON state when the coupling state specifying signal SLa[m] is at a high level, and is in an OFF state when the coupling state specifying signal SLa[m] is at a low level. Similarly, regarding each of the integers m from 1 to M, the switch SWb[m] is turned on and off in accordance with the coupling state specifying signal SLb[m]. For example, the switch SWb[m] is in an ON state when the coupling state specifying signal SLb[m] is at a high level, and is in an OFF state when the coupling state specifying signal SLb[m] is at a low level. In addition, regarding each of the integers m from 1 to M, the switch SWc[m] is turned on and off according to the coupling state specifying signal SLc[m]. For example, the switch SWc[m] is in an ON state when the coupling state specifying signal SLc[m] is at a high level, and is in an OFF state when the coupling state specifying signal SLc[m] is at a low level. As described above, the switching circuit 18 supplies a portion or all of the waveform included in the drive signal Com as the supply signal Vin to the drive element E of each of one or more ejection sections D selected from the M ejection sections D.

Although FIG. 7 illustrates the switching circuit 18 of the head chip 51a1, the head chips 51 other than the head chip 51a1 are different from the head chip 51a1 only in one or a plurality of drive signals Com out of the drive signal ComAa, the drive signal ComBa, and the drive signal ComC1, and thus the illustration and description thereof will be omitted.

### A6: Drive Signal Com

FIG. 8 is a diagram illustrating the drive signal Com for generating the supply signal Vin to be supplied to the head chip 51a1. In the present embodiment, an operation period of the liquid ejecting apparatus 100 includes one or a plurality of drive periods Tu. In general, the liquid ejecting apparatus 100 forms the image indicated by the image data Img by ejecting the liquid from each of the ejection sections D once or a plurality of times over a plurality of continuous or intermittent drive periods Tu.

As illustrated in FIG. 8, the control circuit 21 outputs the latch signal LAT having a pulse PlsL. As a result, the control circuit 21 defines the drive period Tu as a period from a rising edge of the pulse PlsL to the next rising edge of the pulse PlsL. A specific length of the drive period Tu is not particularly limited.

The print data signal SI includes the individual specifying signals Sd[1] to Sd[M] for specifying driving modes of the ejection sections D[1] to D[M], respectively, in each of drive periods Tu. As described above, regarding each of the integers m from 1 to M, the coupling state specifying circuit 18a generates the coupling state specifying signals SLa[m], SLb[m], and SLc[m] based on the individual specifying signal Sd[m] in the drive period Tu.

Regarding each of the integers m from 1 to M, the individual specifying signal Sd[m] is a signal for specifying any one of three driving modes which are ejection of liquid in an amount corresponding to a large dot, ejection of liquid in an amount corresponding to a small dot, and minute vibration for the ejection section D[m] in each of the drive periods Tu. The amount corresponding to the large dot may be hereinafter referred to as a “large amount”. Further, the amount corresponding to the small dot may be hereinafter referred to as a “small amount”.

First, the drive signal ComAa will be described. As illustrated in FIG. 8, the drive signal ComAa includes a start electrical potential maintained element asAa, an ejection pulse PAa for forming a large dot, and an end electrical potential maintained element aeAa in this order in one drive period Tu.

As illustrated in FIG. 8, the start electrical potential maintained element asAa maintains a reference electrical potential VOAa from the start of the one drive period Tu to the start of the ejection pulse PAa. The end electrical potential maintained element aeAa maintains the reference electrical potential VOAa from the end of the ejection pulse PAa to the end of the one drive period Tu.

The ejection pulse PAa includes an ejection waveform element DRAa and a residual vibration suppression element EDAa. The ejection waveform element DRAa changes pressure applied to the liquid in the pressure chamber C such that a droplet in the large amount is ejected from the nozzle N. The ejection waveform element DRAa includes a filling element d1, an electrical potential maintained element pwh1, and an ejection element c1 in this order. The filling element d1 changes from the reference electrical potential VOAa to a lowest electrical potential VLAa to generate negative pressure in the pressure chamber C. The lowest electrical potential VLAa is the lowest electrical potential in the ejection pulse PAa. The ending edge of the filling element d1 is coupled to the starting edge of the electrical potential maintained element pwh1. The electrical potential maintained element pwh1 maintains the lowest electrical potential VLAa. The ending edge of the electrical potential maintained element pwh1 is coupled to the ejection element c1. The ejection element c1 changes from the lowest electrical potential VLAa to a highest electrical potential VHAa to generate positive pressure in the pressure chamber C. The highest electrical potential VHAa is the highest electrical potential in the ejection pulse PAa. When the drive element E receives the supply of the ejection waveform element DRAa, the drive element E generates negative pressure in the pressure chamber C based on the filling element d1 and then generates positive pressure in the pressure chamber C based on the ejection element c1 so as to eject a droplet from the nozzle N.

FIG. 8 illustrates states of the meniscus NIN based on the filling element d1 and the ejection element c1. Based on the filling element d1, the meniscus MN is drawn in the Z1 direction. Based on the ejection element c1, the meniscus MN is pushed out in the Z2 direction, and a droplet DL in the large amount is ejected from the nozzle N.

The residual vibration suppression element EDAa reduces a change in the pressure applied to the liquid in the pressure chamber C according to the natural vibration period of the ejection section D, while the change in the pressure remains after the droplet is ejected from the nozzle N. Hereinafter, the change in the pressure remaining after the liquid is ejected from the nozzle N may be referred to as “residual vibration”. The residual vibration suppression element EDAa includes a first damping maintained element pwh2 and a first damping expansion element d2 in this order. The first damping maintained element pwh2 maintains a constant electrical potential from the ending edge of the ejection element c1. In the example illustrated in FIG. 8, the first damping maintained element pwh2 maintains the highest electrical potential VHAa. The first damping expansion element d2 starts changing the electrical potential from the ending edge of the first damping maintained element pwh2 to expand the pressure chamber C. The first damping expansion element d2 changes the electrical potential from the highest electrical potential VHAa to the reference electrical potential VOAa.

Next, the drive signal ComBa will be described. As illustrated in FIG. 8, the drive signal ComBa includes a start electrical potential maintained element asBa, an ejection pulse PBa for forming a small dot, and an end electrical potential maintained element aeBa in this order.

As illustrated in FIG. 8, the start electrical potential maintained element asBa maintains a reference electrical potential VOBa from the start of the one drive period Tu to the start of the ejection pulse PBa. The end electrical potential maintained element aeBa maintains the reference electrical potential VOBa from the end of the ejection pulse PBa to the end of the one drive period Tu.

The ejection pulse PBa includes an ejection waveform element DRBa and a residual vibration suppression element EDBa. The ejection waveform element DRBa changes the pressure applied to the liquid in the pressure chamber C such that a droplet in the small amount is ejected from the nozzle N. The ejection waveform element DRBa includes a filling element d4, an electrical potential maintained element pwh5, a contraction element c3, an electrical potential maintained element pwh6, and a division element d5 in this order. The filling element d4 changes from the reference electrical potential VOBa to a lowest electrical potential VLBa to generate negative pressure in the pressure chamber C. The lowest electrical potential VLBa is the lowest electrical potential in the ejection pulse PBa. The ending edge of the filling element d4 is coupled to the starting edge of the electrical potential maintained element pwh5. The electrical potential maintained element pwh5 maintains the lowest electrical potential VLBa. The ending edge of the electrical potential maintained element pwh5 is coupled to the starting edge of the contraction element c3. The contraction element c3 changes from the lowest electrical potential VLBa to an electrical potential V1Ba to contract the pressure chamber C and cause a liquid column to protrude from the nozzle N. The electrical potential V1Ba is higher than the reference electrical potential VOBa. The ending edge of the contraction element c3 is coupled to the starting edge of the electrical potential maintained element pwh6. The electrical potential maintained element pwh6 maintains the electrical potential V1Ba. The ending edge of the electrical potential maintained element pwh6 is coupled to the starting edge of the division element d5. The division element d5 changes from the electrical potential V1Ba to an electrical potential V2Ba to expand the pressure chamber C after the contraction element c3 and to divide the liquid column into a plurality of portions.

The residual vibration suppression element EDBa attenuates the residual vibration. The residual vibration suppression element EDBa includes a third damping maintained element pwh3, a second damping contraction element c2, a fourth damping maintained element pwh4, and a second damping expansion element d3 in this order. The third damping maintained element pwh3 maintains the electrical potential V2Ba as a constant electrical potential from the ending edge of the division element d5. The second damping contraction element c2 changes from the electrical potential V2Ba to a highest electrical potential VHBa to contract the pressure chamber C from the ending edge of the third damping maintained element pwh3. The highest electrical potential VHBa is the highest electrical potential in the ejection pulse PBa. The fourth damping maintained element pwh4 maintains the highest electrical potential VHBa as a constant electrical potential from the ending edge of the second damping contraction element c2. The second damping expansion element d3 changes from the highest electrical potential VHBa to the reference electrical potential VOBa to expand the pressure chamber C from the ending edge of the fourth damping maintained element pwh4.

FIG. 8 illustrates states of the meniscus MN based on the contraction element c3 and the division element d5. The contraction element C3 contracts the pressure chamber C to push out the meniscus MN in the Z2 direction and causes a liquid column DC to protrude from the nozzle N. The division element d5 draws the meniscus MN in the Z1 direction to divide the liquid column into a plurality of portions, and causes one droplet obtained by dividing the liquid column DC to be ejected from the nozzle N as a droplet DS in the small amount.

In the following description, pulses that include the ejection pulse PAa and the ejection pulse PBa and causes the liquid to be ejected from the nozzle N may be collectively referred to as ejection pulses PD. The difference between the highest electrical potential and the lowest electrical potential of each of the ejection pulses PD may be referred to as an electrical potential difference ΔVh. The electrical potential difference ΔVh of the ejection pulse PAa illustrated in FIG. 8 is the difference ΔVhAa between the highest electrical potential VHAa and the lowest electrical potential VLAa. Further, the electrical potential difference ΔVh of the ejection pulse PBa illustrated in FIG. 8 is the difference ΔVhBa between the highest electrical potential VHBa and the lowest electrical potential VLBa.

Hereinafter, ejection waveform elements that are included in the ejection pulses PD and include the ejection waveform element DRAa and the ejection waveform element DRBa may be collectively referred to as ejection waveform elements DR. Similarly, residual vibration suppression elements that are included in the ejection pulses PD and include the residual vibration suppression element EDAa and the residual vibration suppression element EDBa may be collectively referred to as residual vibration suppression elements ED.

As is understood from FIG. 8, each of the drive signal ComAa and the drive signal ComBa includes one ejection pulse PD in the one drive period Tu. The one ejection pulse PD of each of the drive signal ComAa and the drive signal ComBa is an example of “at least one ejection pulse”.

Next, the drive signal ComC1 will be described. As illustrated in FIG. 8, the drive signal ComC1 includes a start electrical potential maintained element asC1, a minute vibration pulse PC1 that generates minute vibration, and an end electrical potential maintained element aeC1.

As illustrated in FIG. 8, the start electrical potential maintained element asC1 maintains a reference electrical potential VOC1 from the start of the one drive period Tu to the start of the minute vibration pulse PC1. The end electrical potential maintained element aeC1 maintains the reference electrical potential VOC1 from the end of the minute vibration pulse PC1 to the end of the one drive period Tu.

The minute vibration pulse PC1 has a trapezoidal wave and includes an expansion element e1, a maintained element e2, and a contraction element e3 in this order. The expansion element e1 changes from the reference electrical potential VOC1 to a lowest electrical potential VLC1 of the minute vibration pulse PC1. The lowest electrical potential VLC1 is the lowest electrical potential in the minute vibration pulse PC1. The maintained element e2 maintains the lowest electrical potential VLC1. The contraction element e3 returns from the lowest electrical potential VLC1 to the reference electrical potential VOC1.

In the following description, a pulse that includes the minute vibration pulse PC1 and generates minute vibration may be referred to as a minute vibration pulse PC. In addition, each of electrical potentials that include the reference electrical potential VOAa, the reference electrical potential VOBa, and the reference electrical potential VOC1 and are an electrical potential at the start of the one drive period Tu and an electrical potential at the end of the one drive period Tu in each of the drive signals Com may be referred to as a reference electrical potential V0. The reference electrical potential V0 is an example of a “first electrical potential”. In addition, each of elements that include the start electrical potential maintained element asAa, the start electrical potential maintained element asBa, and the start electrical potential maintained element asC1 and maintain the reference electrical potential V0 from the start of the one drive period Tu may be referred to as a start electrical potential maintained element as. In addition, each of elements that include the end electrical potential maintained element aeAa, the end electrical potential maintained element aeBa, and the end electrical potential maintained element aeC1 and maintain the reference electrical potential V0 until the end of the one drive period Tu may be referred to as an end electrical potential maintained element ae.

Although not illustrated, the drive signal ComAb and the drive signal ComAc include the same elements as those included in the drive signal ComAa. Therefore, the elements of the drive signal ComAb and the drive signal ComAc may also be described with reference signs as in the start electrical potential maintained element as. Similarly, although not illustrated, the drive signal ComBb and the drive signal ComBc include the same elements as those included in the drive signal ComBa. Therefore, the elements of the drive signal ComBb and the drive signal ComBc may also be described with reference signs as in the start electrical potential maintained element as. The drive signal ComC2 includes the same elements as those included in the drive signal ComC1. However, the periods or the electrical potentials of the respective elements in the drive signal ComAa, the drive signal ComAb, and the drive signal ComAc may be different from each other due to the adjustment of the drive signal Com to be described later.

The waveform information CI illustrated in FIG. 2 indicates a waveform shape of the drive signal Com. Specifically, the waveform information CI indicates the waveform shape of each of the drive signal ComAa, the drive signal ComAb, the drive signal ComAc, the drive signal ComBa, the drive signal ComBb, the drive signal ComBc, the drive signal ComC1, and the drive signal ComC2. For example, the waveform information CI includes ending edge information including information indicating the time of the ending edge of each of the elements included in each of the drive signals Com and information indicating the electrical potential of the ending edge of each of the elements included in each of the drive signals Com. For example, regarding the drive signal ComAa, the waveform information CI includes ending edge information of the start electrical potential maintained element asAa, ending edge information of the filling element d1, ending edge information of the electrical potential maintained element pwh1, ending edge information of the ejection element c1, ending edge information of the first damping maintained element pwh2, ending edge information of the first damping expansion element d2, and ending edge information of the end electrical potential maintained element aeAa. Information indicating an ending edge time included in the ending edge information of the end electrical potential maintained element aeAa indicates the one drive period Tu.

### A7: Regarding Adjustment of Drive Signal Com

A certain degree of manufacturing error may occur in a head chip 51. Then, amounts of liquid ejected by two head chips 51 may be different from each other due to the manufacturing error. For example, even if the same drive signal Com is applied to each of the two head chips 51, the shapes or the like of the pressure chambers C may be different from each other due to the manufacturing error, and as a result, the amounts of liquid ejected by the two head chips 51 may be different from each other. In order to make the amounts of liquid ejected by the two head chips 51 uniform, it is considered to adjust the drive signal Com. In the present embodiment, it is necessary to make large amounts of liquid ejected from the six head chips 51 uniform and to make small amounts of liquid ejected from the six head chips 51 uniform. Therefore, it is necessary to adjust the drive signal ComAa so as to eject uniform large amounts of liquid from the head chips 51a1 and 51a2, adjust the drive signal ComAb so as to eject uniform large amounts of liquid from the head chips 51b1 and 51b2, and adjust the drive signal ComAc so as to eject uniform large amounts of liquid from the head chips 51c1 and 51c2. Similarly, it is necessary to adjust the drive signal ComBa so as to eject uniform small amounts of liquid from the head chips 51a1 and 51a2, adjust the drive signal ComBb so as to eject uniform small amounts of liquid from the head chips 51b1 and 51b2, and adjust the drive signal ComBc so as to eject uniform small amounts of liquid from the head chips 51c1 and 51c2.

In addition, if the reference electrical potentials V0 of two or more drive signals Com which can be supplied to a certain head chip 51 are different from each other, and a drive signal Com that is supplied to the head chip 51 is switched, there is a possibility that an ejection failure in which a droplet is ejected in an unintended manner may occur. For example, since the drive signal ComAa, the drive signal ComBa, and the drive signal ComC1 can be supplied to the head chip 51a1, the reference electrical potential VOAa, the reference electrical potential VOBa, and the reference electrical potential VOC1 need to be the same electrical potential in order to prevent the ejection failure from occurring from the head chip 51a1 when the drive signal Com that is supplied to the head chip 51a1 is switched. In addition, since the drive signal ComAa, the drive signal ComBa, and the drive signal ComC2 can be supplied to the head chip 51a2, the reference electrical potential VOAa, the reference electrical potential VOBa, and the reference electrical potential ComC2 of the drive signal v0 need to be the same electrical potential in order to prevent the ejection failure from the head chip 51a2 when the drive signal Com that is supplied to the head chip 51a2 is switched. However, the drive signal ComC1 can also be supplied to the head chip 51b1 and the head chip 51c1. Further, the drive signal ComC2 can also be supplied to the head chip 51b2 and the head chip 51c2. Therefore, in the present embodiment, in order to prevent the ejection failure from occurring from the head chips 51 when the drive signals Com that are supplied to the head chips 51 are switched, all of the reference electrical potentials V0 of all of the eight drive signals Com need to be the same electrical potential.

As described above, it is necessary to adjust the drive signals Com while maintaining a state in which the reference electrical potentials V0 of all of the eight drive signals Com are the same electrical potential.

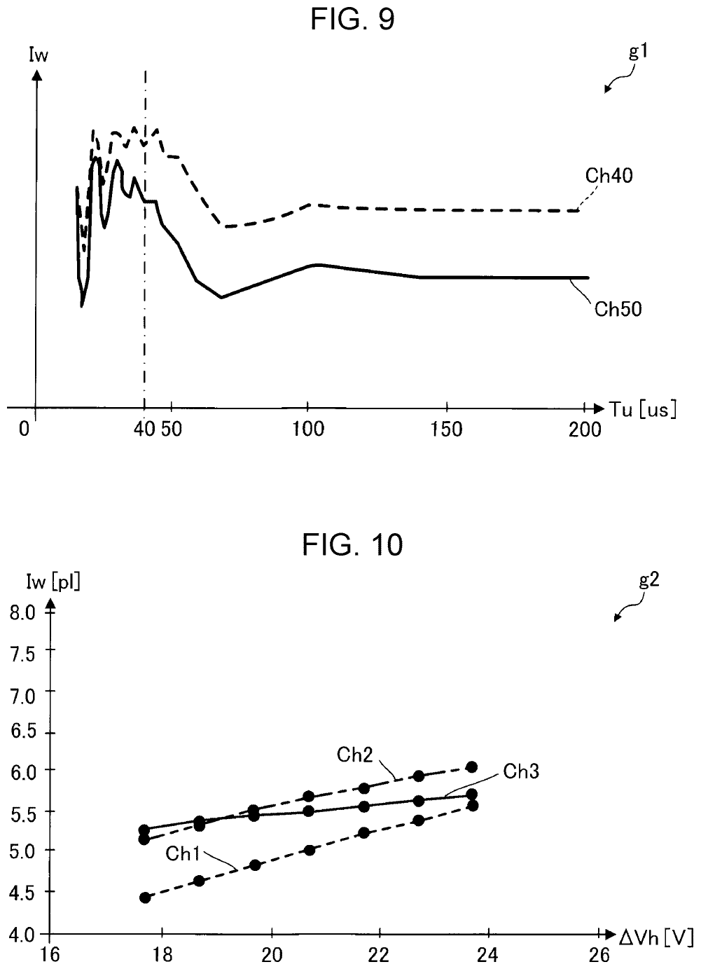

As an example of a method of adjusting the drive signals Com, a method of adjusting the electrical potential differences ΔVh of the ejection pulses PD included in the drive signals Com while fixing the reference electrical potentials V0 in the drive signals Com is considered. In general, the amount of liquid to be ejected can be increased by setting each of the electrical potential differences ΔVh to a large value. However, the experiments by the inventors have shown that even when the electrical potential differences ΔVh are set to be large, the amount of liquid to be ejected does not necessarily increase in a case where the drive period Tu is short. Hereinafter, the reciprocal of the drive period Tu may be referred to as a drive frequency. Further, a state in which the drive period Tu is set to be short, in other words, a state in which the drive frequency is set to be high may be referred to as high-frequency driving. On the other hand, a state in which the drive period Tu is set to be long, in other words, a state in which the drive frequency is set to be low may be referred to as low-frequency driving. The relationship between the drive period Tu and the amount of liquid to be ejected will be described with reference to FIG. 9.

FIG. 9 is a diagram illustrating the relationship between the drive period Tu and the amount Iw of liquid to be ejected. A graph g1 illustrated in FIG. 9 indicates the amount Iw of liquid to be ejected with respect to the drive period Tu. The horizontal axis of the graph g1 represents the length of the drive period Tu. In FIG. 9, s represents microseconds. The vertical axis of the graph g1 represents the amount Iw of liquid to be ejected. An ejection amount characteristic Ch50 indicated in the graph g1 indicates a characteristic of the amount Iw of liquid to be ejected when the ratio of the difference between the lowest electrical potential and the reference electrical potential V0 to the electrical potential difference ΔVh is 50%. Hereinafter, the ratio of the difference between the lowest electrical potential and the reference electrical potential V0 to the electrical potential difference ΔVh may be referred to as an “electrical potential difference ratio”. An ejection amount characteristic Ch40 indicated in the graph g1 indicates a characteristic of the amount Iw of liquid to be ejected when the electrical potential difference ratio is 40%. The lower the electrical potential difference ratio, the greater the electrical potential difference ΔVh.

As is understood from FIG. 9, when the drive period Tu is greater than or equal to s, the amount Iw of liquid to be ejected is increased by changing the electrical potential difference ratio from 50% to 40%, that is, by increasing the electrical potential difference ΔVh. However, a change in the amount of liquid to be ejected when the drive period Tu is less than 40 μs is less than a change in the amount of liquid to be ejected when the drive period Tu is greater than 40 μs. That is, the amount of change in the amount of liquid to be ejected per 1 V of the electrical potential difference ΔVh decreases as the drive frequency is set to be higher in the high-frequency driving.

FIG. 10 is a diagram illustrating the relationship between the electrical potential difference ΔVh and the amount Iw of liquid to be ejected for each of drive frequencies in the method of adjusting the electrical potential difference ΔVh. A graph g2 illustrated in FIG. 10 indicates the relationship between the electrical potential difference ΔVh and the amount Iw of liquid to be ejected for each of the drive frequencies. The horizontal axis of the graph g2 represents the electrical potential difference ΔVh. The vertical axis of the graph g2 represents the amount Iw of liquid to be ejected. In the graph g2, pl represents picoliters. An ejection amount characteristic Ch1 indicated in the graph g2 indicates a characteristic of the amount Iw of liquid to be ejected with respect to the electrical potential difference ΔVh when the drive frequency is 5.0 kHz. kHz represents kilohertz. An ejection amount characteristic Ch2 indicated in the graph g2 indicates a characteristic of the amount Iw of liquid to be ejected with respect to the electrical potential difference ΔVh when the drive frequency is 31.5 kHz. An ejection amount characteristic Ch3 indicated in the graph g2 indicates a characteristic of the amount Iw of liquid to be ejected with respect to the electrical potential difference ΔVh when the drive frequency is 63.0 kHz.

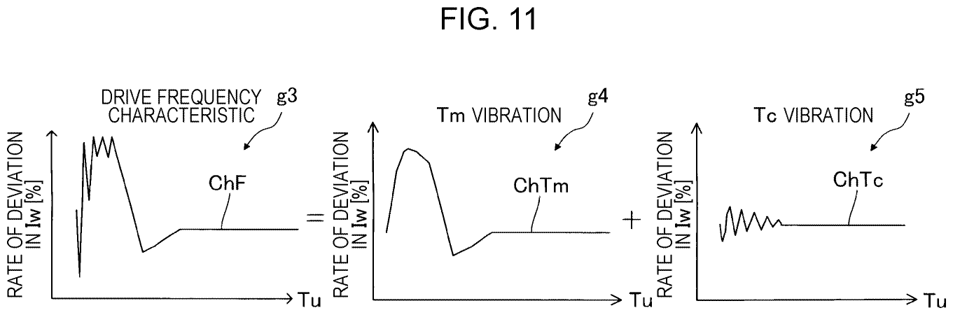

As is understood from the ejection amount characteristics Ch1, Ch2, and Ch3, when the drive frequency is high, even if the electrical potential difference ΔVh is changed, a change in the amount Iw of liquid to be ejected is small. That is, the amount of change in the amount of liquid to be ejected per 1 V of the electrical potential difference ΔVh in the high-frequency driving is less than that in the low-frequency driving. Therefore, when the amount by which the electrical potential difference ΔVh is adjusted is further increased in order to secure the amount of liquid to be ejected in the high-frequency driving, the speed at which a droplet is ejected becomes excessively higher than a desired speed in the low-frequency driving. As a result, there is a possibility that a droplet that has landed deviates from a desired position in the low-frequency driving in printing of a ruled line or the like. Drive frequency characteristics indicating the rate of deviation in the amount Iw of liquid ejected with respect to the drive period Tu will be described with reference to FIG. 11.

FIG. 11 is a diagram illustrating the drive frequency characteristics. A graph g3 illustrated on the left side of FIG. 11 indicates a drive frequency characteristic ChF indicating the rate of deviation in the amount Iw of liquid ejected with respect to the drive period Tu. The drive frequency characteristic ChF is the sum of a drive frequency characteristic ChTm due to an effect of Tm vibration indicated by a graph g4 illustrated in a central portion of FIG. 11 and a drive frequency characteristic ChTc due to an effect of Tc vibration indicated by a graph g5 illustrated on the right side of FIG. 11. The Tm vibration indicates vibration of the meniscus MN. The Tc vibration indicates natural vibration of the liquid in a flow path included in the ejection section D. Further, in the following description, the natural vibration period of the ejection section D may be referred to as a natural vibration period Tc.

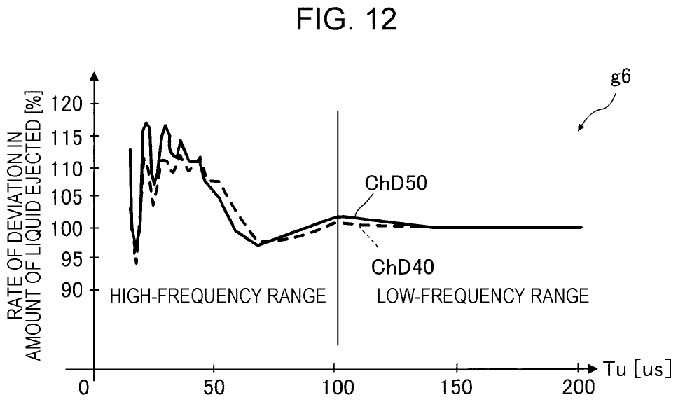

The effect of the Tm vibration is high in the high-frequency driving. Therefore, an effect of residual vibration which is the Tc vibration after the ejection of a droplet and an effect of refilling which causes the Tm vibration after the ejection of liquid in the low-frequency driving are less than those in the high-frequency driving. In the low-frequency driving, after the meniscus MN returns to a state at the time of non-driving, the next drive signal Com is applied. On the other hand, in the high-frequency driving, the amount of liquid ejected may easily change due to the effect of the Tm vibration of the meniscus MN and the Tc vibration in the flow path of the ejection section D. The reason why the amount of change in the amount of liquid ejected varies depending on the level of the drive frequency will be described with reference to FIG. 12.

FIG. 12 is a diagram illustrating the reason why the amount of change in the amount of liquid ejected varies depending on the level of the drive frequency. A graph g6 illustrated in FIG. 12 indicates an ejection amount characteristic ChD50 and an ejection amount characteristic ChD40. The ejection amount characteristic ChD50 indicates the rate of deviation in the amount Iw of liquid ejected with respect to the drive frequency when the electrical potential difference ratio is 50%. The ejection amount characteristic ChD40 indicates the rate of deviation in the amount Iw of liquid ejected with respect to the drive frequency when the electrical potential difference ratio is 40%. The vertical axis of the graph g6 indicates the rate [%] of deviation in the amount Iw of liquid ejected when the amount Iw of liquid to be ejected in a low frequency range in each of the ejection amount characteristic ChD50 and the ejection amount characteristic ChD40 is set to 100%.

As can be understood from the ejection amount characteristic ChD40 and the ejection amount characteristic ChD50, the rate of deviation in the amount of liquid ejected when the electrical potential difference ratio is 40% is lower than that when the electrical potential difference ratio is 50%. That is, in the high-frequency driving, even when a correction amount of the electrical potential difference ΔVh is increased without changing the reference electrical potential V0, the amount Iw of liquid to be ejected is hardly increased. Therefore, in the method of adjusting the electrical potential difference ΔVh without changing the reference electrical potential V0, it is more difficult to increase the amount Iw of liquid to be ejected as the drive frequency is set to be higher in the high-frequency driving.

As described above, the effect of the residual vibration increases as the drive frequency is set to be higher in the high-frequency driving. Therefore, in the present embodiment, and the residual vibration suppression element ED of the ejection pulse PD is adjusted to correct the weight of droplets that are continuously ejected from the nozzle N when the drive signal Com is repeatedly supplied to the drive element E. For example, by adjusting a residual vibration suppression element ED of a certain ejection pulse PD, and supplying the next ejection pulse PD with a large residual vibration remaining, the amount of liquid to be ejected based on the next ejection pulse PD can be increased using the residual vibration. On the other hand, the amount of liquid to be ejected based on the next ejection pulse PD can be reduced by significantly attenuating the residual vibration and supplying the next ejection pulse PD since the residual vibration cannot be used for the next ejection pulse PD.

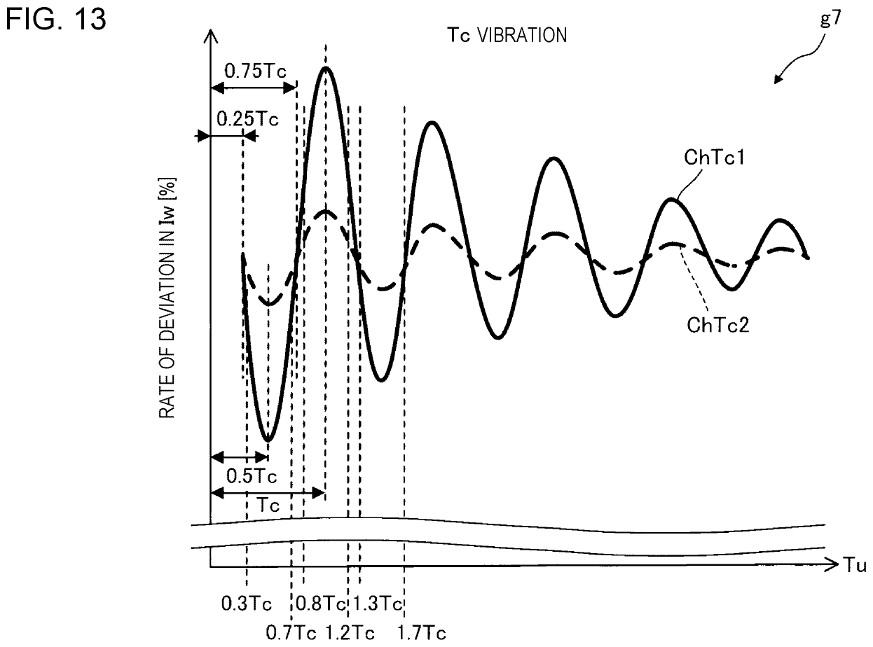

As described above, since the drive frequency characteristic is the sum of the drive frequency characteristic ChTm and the drive frequency characteristic ChTc, the drive frequency characteristic is affected by the natural vibration period Tc. The drive frequency characteristic ChTc when the residual vibration suppression element ED is adjusted will be described with reference to FIG. 13.

FIG. 13 is a diagram illustrating the drive frequency characteristic ChTc when the residual vibration suppression element ED is adjusted. A graph g7 illustrated in FIG. 13 indicates a drive frequency characteristic ChTc1 in a state where the residual vibration suppression element ED is not adjusted, and a drive frequency characteristic ChTc2 in a state where the residual vibration suppression element ED is adjusted.

As is understood from the drive frequency characteristics ChTc1 and ChTc2, when the drive period Tu is (0.5×n−0.25) times or (0.5×n+0.25) times the natural vibration period Tc, the amount Iw of liquid to be ejected does not change even when the residual vibration suppression element ED is adjusted. In this case, n is an integer greater than or equal to 1. For example, in the drive frequency characteristic ChTc1 and the drive frequency characteristic ChTc2, the rates of deviation in the amount Iw of liquid ejected are the same when the drive period Tu is 0.25Tc and 0.75Tc and n is 1. That is, a case where the drive period Tu is 0.25Tc or 0.75Tc indicates that the amount Iw of liquid ejected does not change even when the residual vibration suppression element ED is adjusted. Therefore, in the present embodiment, in order to change the amount Iw of liquid to be ejected, the drive period Tu satisfies the following Expression (1).

$$( 0.5 \times n - 0.2 ) \times T c < T u < ( 0.5 \times n + 0.2 ) \times Tc \qquad ( 1 )$$

In the range illustrated in FIG. 13, the drive period Tu is greater than 0.3Tc and less than 0.7Tc, greater than 0.8Tc and less than 1.2Tc, or greater than 1.3Tc and less than 1.7Tc. Further, as can be understood from the drive frequency characteristics ChTc1 and ChTc2, the closer the drive period Tu is to 0.5×n times the natural vibration period Tc, the easier it is to adjust the amount Iw of liquid to be ejected.

### A8: Process of Correcting Amount of Liquid to be Ejected

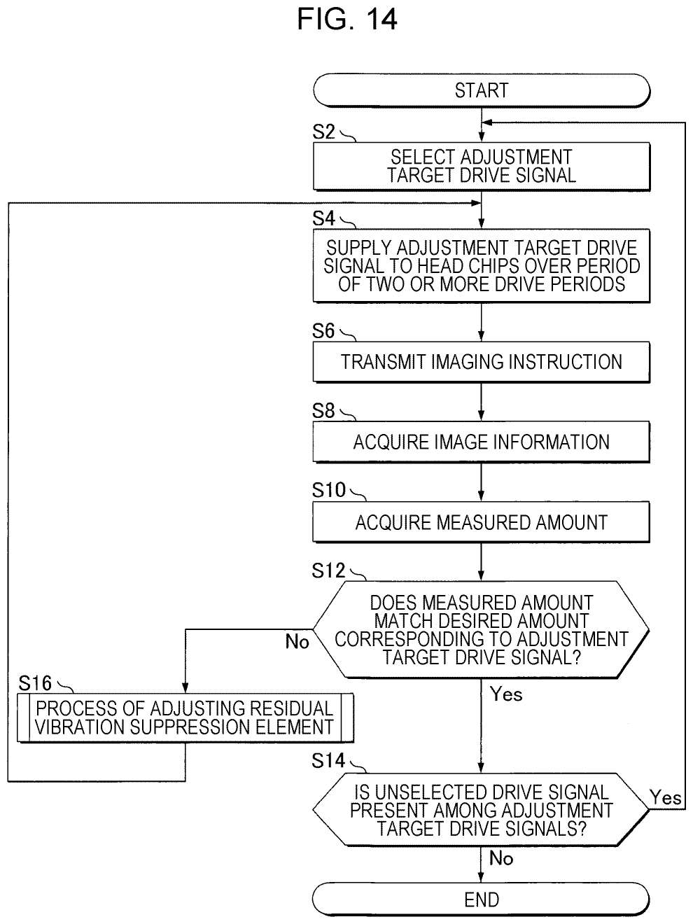

FIG. 14 is a flowchart illustrating an example of a process of correcting an amount of liquid to be ejected. The process of correcting an amount of liquid to be ejected is executed, for example, when the liquid ejecting apparatus 100 is powered on or when the liquid ejecting apparatus 100 receives an instruction from a user of the liquid ejecting apparatus 100. In step S2, the control circuit 21 selects one drive signal Com from two or more of the drive signals Com having the ejection pulses PD. Specifically, the control circuit 21 selects a drive signal from among the drive signal ComAa, the drive signal ComAb, the drive signal ComAc, the drive signal ComBa, the drive signal ComBb, and the drive signal ComBc in order from the top drive signal. Hereinafter, the drive signal Com selected in step S2 may be referred to as an adjustment target drive signal Com-Adj.

Next, in step S4, the control circuit 21 causes the drive signal generating circuit 24 to supply the adjustment target drive signal Com-Adj to the head chips 51 over a period of two or more drive periods Tu. Further, in step S6, the control circuit 21 transmits the imaging instruction Sk2 to the imaging device 40 at a timing at which droplets continuously ejected in two or more drive periods Tu can be imaged.

After the completion of the process in step S6, the control circuit 21 acquires image information GI from the imaging device 40 in step S8. In addition, in step S10, the control circuit 21 functions as the acquirer 211, analyzes the image information GI, and acquires information indicating the weight of the droplets continuously ejected based on the drive signal Com supplied by the process in step S4. Hereinafter, the weight of the droplets indicated in the information acquired in step S4 may be referred to as a “measured amount”.

After the completion of the process in step S10, the control circuit 21 determines whether or not the measured amount matches a desired amount corresponding to the adjustment target drive signal Com-Adj in step S12. The desired amount corresponding to the adjustment target drive signal Com-Adj is the large amount when the adjustment target drive signal Com-Adj is a drive signal ComA among the drive signals ComA, and is the small amount when the adjustment target drive signal Com-Adj is a drive signal ComB among the drive signals ComB. A case where the measured amount matches the desired amount includes not only a case where the measured amount completely matches the desired amount, but also a case where a dot formed by a droplet in the measured amount and a dot formed by a droplet in the desired amount can be regarded to be the same when an error is taken into account.

When the result of the determination in step S12 is affirmative, the control circuit 21 updates the waveform information CI of the drive signal Com corresponding to the adjustment target drive signal Com-Adj, and determines whether or not an unselected drive signal Com is present among adjustment target drive signals Com-Adj in step S14. When the result of the determination in step S14 is affirmative, the control circuit 21 executes the process in step S2 again. When the result of the determination in step S14 is negative, the control circuit 21 ends the series of processes illustrated in FIG. 14.

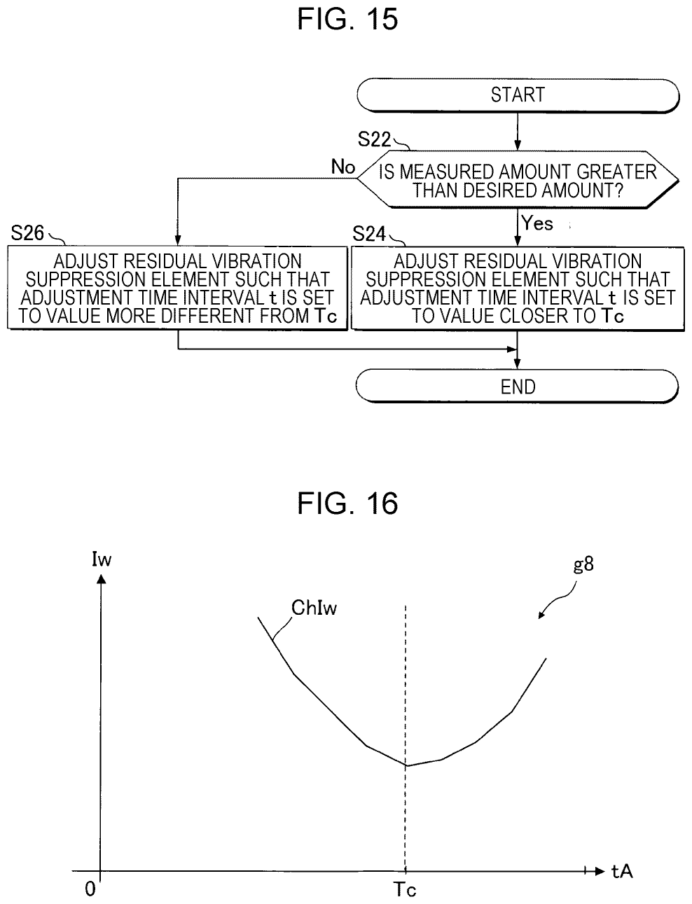

When the result of the determination in step S12 is negative, the control circuit 21 functions as the adjuster 213 to execute a process of adjusting the residual vibration suppression element in step S16. After the completion of the process in step S16, the control circuit 21 executes the process in step S4 again. The process of adjusting the residual vibration suppression element will be described with reference to FIG. 15.

FIG. 15 is a flowchart illustrating an example of the process of adjusting the residual vibration suppression element. The process of adjusting the residual vibration suppression element is a process of adjusting the residual vibration suppression element ED to correct the weight of droplets that are continuously ejected from the nozzle N when the drive signal Com is supplied to each of the drive elements E over a period of two or more drive periods Tu.

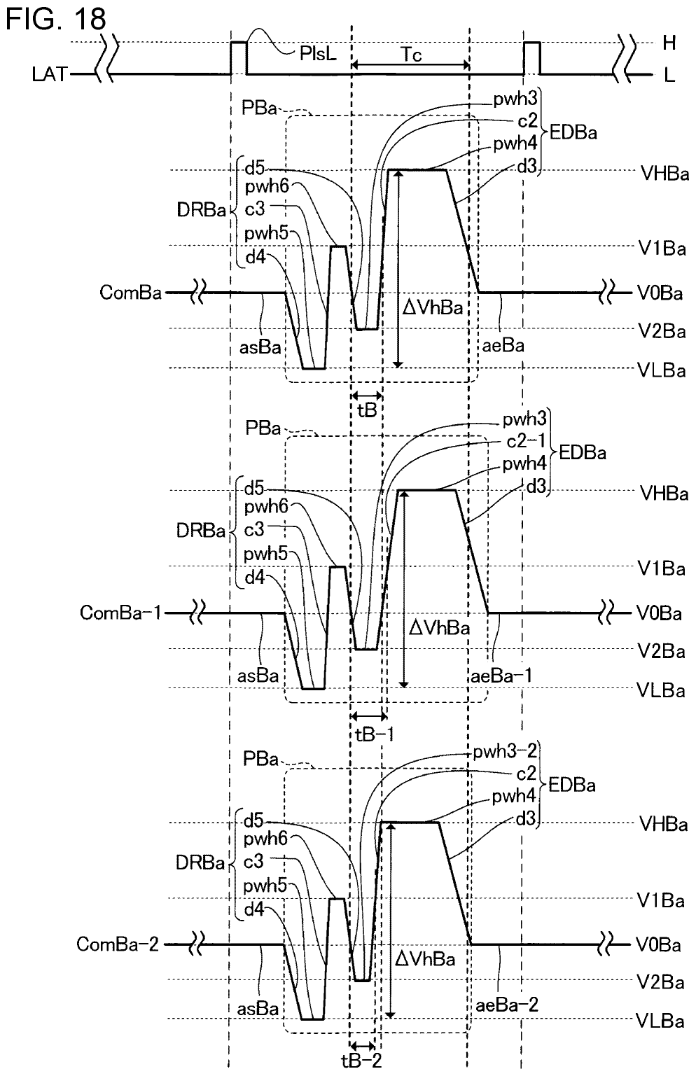

In step S22, the control circuit 21 determines whether or not the measured amount is greater than the desired amount. When the result of the determination in step S22 is affirmative, it is necessary to reduce the amount of liquid to be ejected. In step S24, the control circuit 21 adjusts the residual vibration suppression element ED such that an adjustment time interval t is set to a value closer to the natural vibration period Tc than the current value of the adjustment time interval t before the adjustment is. After the completion of the process in step S24, the control circuit 21 ends the series of processes illustrated in FIG. 15. When the result of the determination in step S22 is negative, it is necessary to increase the amount of liquid to be ejected. In step S26, the control circuit 21 adjusts the residual vibration suppression element ED such that the adjustment time interval t is set to a value more different from Tc than the current value of the adjustment time interval t before the adjustment is. However, when the adjustment target drive signal Com-Adj is a drive signal ComB among the drive signals ComB, the control circuit 21 compares the maximum damping time interval instead of the natural vibration period Tc with the current value of the adjustment time interval t in step S24 and step S26. The maximum damping time interval will be described later with reference to FIG. 18 After the completion of the process in step S26, the control circuit 21 ends the series of processes illustrated in FIG. 15 and returns to the process in step S4 illustrated in FIG. 14.

When the adjustment target drive signal Com-Adj is the drive signal ComAa, the adjustment time interval t is an adjustment time interval tA illustrated in FIG. 8. The adjustment time interval tA is from the center time of the period of the ejection element c1 to the center time of the period of the first damping expansion element d2 in the drive signal ComAa. Further, in the first embodiment, the control circuit 21 sets the adjustment time interval tA to be greater than 0.5Tc and less than 1.5Tc. Even when the adjustment target drive signal Com-Adj is the drive signal ComAb or the drive signal ComAc, the adjustment time interval tA is from the center time of the period of the ejection element c1 to the center time of the period of the first damping expansion element d2. The adjustment time interval tA is an example of a “first time interval”. The relationship of the amount Iw of liquid to be ejected when the adjustment time interval tA is changed will be described with reference to FIG. 16.

FIG. 16 is a diagram illustrating the relationship between the period of the adjustment time interval tA and the amount Iw of liquid to be ejected. A graph g8 illustrated in FIG. 16 indicates the amount Iw of liquid to be ejected with respect to the adjustment time interval tA. The horizontal axis of the graph g8 indicates the length of the adjustment time interval tA. The vertical axis of the graph g8 represents the amount Iw of liquid to be ejected. An ejection amount characteristic ChIw indicated in the graph g8 indicates a characteristic of the amount Iw of liquid to be ejected with respect to the adjustment time interval tA.

As indicated by the ejection amount characteristic ChIw, the amount Iw of liquid to be ejected is smallest when the adjustment time interval tA matches the natural vibration period Tc. The amount Iw of liquid to be ejected increases as the adjustment time interval tA is more different from the natural vibration period Tc.

When the adjustment target drive signal Com-Adj is the drive signal ComBa, the adjustment time interval t is an adjustment time interval tB illustrated in FIG. 8. The adjustment time interval tB will be described later in the description of FIG. 18.

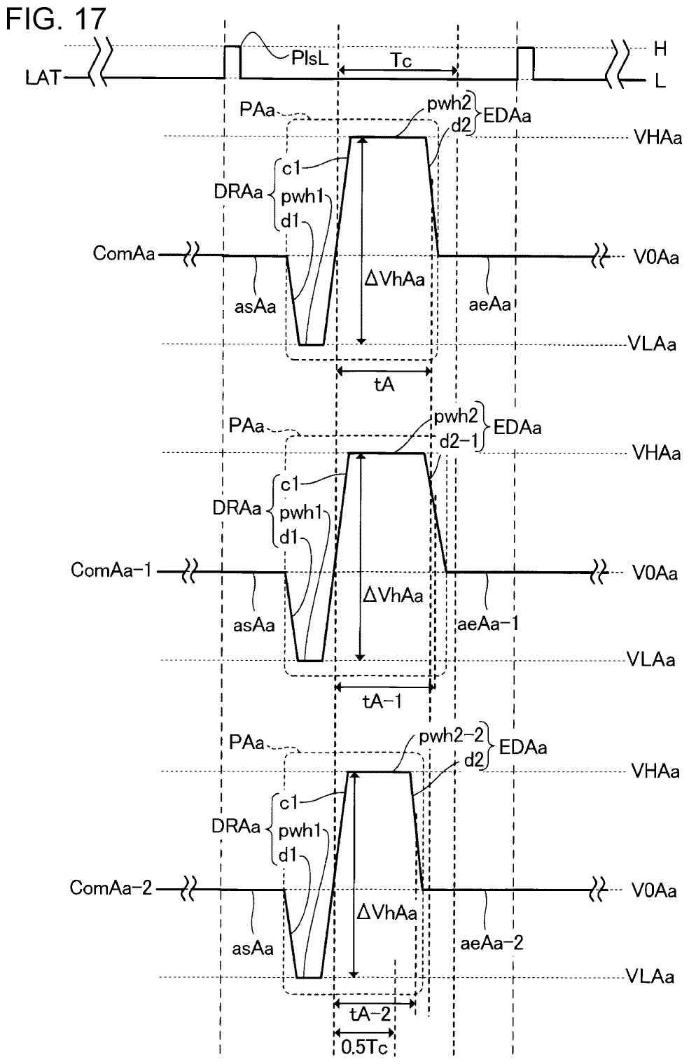

An example of the adjustment of the residual vibration suppression element ED when the adjustment target drive signal Com-Adj is the drive signal ComAa will be described with reference to FIG. 17. An example of the adjustment of the residual vibration suppression element ED when the adjustment target drive signal Com-Adj is the drive signal ComBa will be described with reference to FIG. 18.

FIG. 17 is a diagram illustrating an example of the adjustment of the residual vibration suppression element ED of the drive signal ComAa. In the adjustment of the residual vibration suppression element ED, the control circuit 21 adjusts at least one of the period of the first damping maintained element pwh2 or the electrical potential change rate of the first damping expansion element d2. The electrical potential change rate is a value obtained by dividing the electrical potential change range by the length of a period in which the electrical potential changes. In the adjustment of the electrical potential change rate of the first damping expansion element d2, the control circuit 21 adjusts the electrical potential change rate of the first damping expansion element d2 by setting the period of the first damping expansion element d2 to be short or long.

In FIG. 17, it is assumed that the adjustment time interval tA is shorter than the natural vibration period Tc. FIG. 17 illustrates, as a drive signal ComAa-1, an example of the drive signal ComAa in which the residual vibration suppression element EDAa is adjusted to set the adjustment time interval tA to a value closer to the natural vibration period Tc than the current value of the adjustment time interval tA before the adjustment is when the process in step S24 is executed, that is, when the amount of liquid to be ejected is reduced. In addition, among the elements of the drive signal ComAa-1, elements different from those of the drive signal ComAa are denoted with a reference sign “−1”. Similarly, FIG. 17 illustrates, as a drive signal ComAa-2, an example of the drive signal ComAa in which the residual vibration suppression element EDAa is adjusted to set the adjustment time interval tA to a value more different from the natural vibration period Tc than the current value of the adjustment time interval tA before the adjustment is when the process in step S26 is executed, that is, when the amount of liquid to be ejected is increased. In addition, among the elements of the drive signal ComAa-2, elements different from those of the drive signal ComAa are denoted with a reference sign “−2”.

The drive signal ComAa-1 is an example in which the electrical potential change rate of the first damping expansion element d2 is adjusted. In the example of the drive signal ComAa-1, the control circuit 21 sets the period of the first damping expansion element d2-1 included in the drive signal ComAa-1 to be longer than the period of the first damping expansion element d2, and thus sets the absolute value of the electrical potential change rate of the first damping expansion element d2-1 to be less than the absolute value of the electrical potential change rate of the first damping expansion element d2. Further, in the drive signal ComAa-1, the period of the end electrical potential maintained element aeAa-1 is set to be shorter than the period of the end electrical potential maintained element aeAa by the amount by which the period of the first damping expansion element d2-1 is set to be longer than the period of the first damping expansion element d2. As a result of setting the absolute value of the electrical potential change rate of the first damping expansion element d2-1 to be small, as is understood from FIG. 17, the adjustment time interval tA-1 in the drive signal ComAa-1 is longer than the adjustment time interval tA and is closer to the natural vibration period Tc, and it is possible to reduce the effect of residual vibration on the next ejection pulse PD. In step S24, the control circuit 21 sets the time of the ending edge of the first damping expansion element d2-1 to be later than the time of the ending edge of the first damping expansion element d2 in the waveform information CI. When the adjustment time interval tA is set to be longer than the natural vibration period Tc, the control circuit 21 sets the period of the first damping expansion element d2-1 included in the drive signal ComAa-1 to be shorter than the period of the first damping expansion element d2, and sets the period of the end electrical potential maintained element aeAa-1 to be longer than the period of the end electrical potential maintained element aeAa.

The drive signal ComAa-2 is an example in which the period of the first damping maintained element pwh2 is adjusted. In the example of the drive signal ComAa-2, the control circuit 21 sets the period of the first damping maintained element pwh2-2 included in the drive signal ComAa-2 to be shorter than the period of the first damping maintained element pwh2. Further, in the drive signal ComAa-2, the period of the end electrical potential maintained element aeAa-2 is set to be longer than the period of the end electrical potential maintained element aeAa by the amount by which the period of the first damping maintained element pwh2-2 is set to be shorter than the period of the first damping maintained element pwh2. As a result of setting the period of the first damping maintained element pwh2-2 to be shorter than the period of the first damping maintained element pwh2, as is understood from FIG. 17, the adjustment time interval tA-2 in the drive signal ComAa-2 is shorter than the adjustment time interval tA and is more different from the natural vibration period Tc than the adjustment interval tA is, and it is possible to increase the effect of the residual vibration on the next ejection pulse PD. However, as described above, the control circuit 21 sets the period of the first damping maintained element pwh2-2 such that the adjustment time interval tA is greater than 0.5Tc. In step S26, the control circuit 21 sets the time of the ending edge of the first damping maintained element pwh2-2 to be earlier than the time of the ending edge of the first damping maintained element pwh2 in the waveform information CI. When the adjustment time interval tA is set to be longer than the natural vibration period Tc, the control circuit 21 sets the period of the first damping maintained element pwh2-2 included in the drive signal ComAa-1 to be longer than the period of the first damping expansion element d2, and sets the period of the end electrical potential maintained element aeAa-1 to be shorter than the period of the end electrical potential maintained element aeAa.

Although not illustrated, when the adjustment time interval tA is to be set to be longer than the natural vibration period Tc and more different from the natural vibration period Tc than the current value of the adjustment time interval tA is, the control circuit 21 sets the period of the first damping maintained element pwh2 such that the adjustment time interval tA is less than 1.5Tc.

FIG. 18 is a diagram illustrating an example of the adjustment of the residual vibration suppression element ED of the drive signal ComBa. The control circuit 21 adjusts at least one of the period of the third damping maintained element pwh3 or the electrical potential change rate of the second damping contraction element c2. In the adjustment of the electrical potential change rate of the second damping contraction element c2, the control circuit 21 adjusts the electrical potential change rate of the second damping contraction element c2 by setting the period of the second damping contraction element c2 to be short or long.

Since the length of the adjustment time interval tB in which the residual vibration can be most suppressed varies depending on the setting of the ejection waveform element DRBa in the ejection pulse PBa, the maximum damping time interval in which the residual vibration can be most suppressed is obtained in advance by an experiment or the like, and a value slightly shifted from the maximum damping time interval is set as the adjustment time interval tB.

In FIG. 18, it is assumed that the adjustment time interval tB is shorter than the above-described maximum damping time interval. FIG. 18 illustrates, as a drive signal ComBa-1, an example of the drive signal ComBa in which the residual vibration suppression element EDBa is adjusted to set the adjustment time interval tB to a value closer to the maximum damping time interval than the current value of the adjustment time interval tB before the adjustment is when the process in step S24 is executed. In addition, among the elements of the drive signal ComBa-1, elements different from those of the drive signal ComBa are denoted by the reference sign “-1”. Similarly, FIG. 18 illustrates, as a drive signal ComBa-2, an example of the drive signal ComBa in which the residual vibration suppression element EDBa is adjusted to set the adjustment time interval tB to a value more different from the maximum damping time interval than the current value of the adjustment time interval tB before the adjustment is when the process in step S26 is executed. In addition, among the elements of the drive signal ComBa-2, elements different from those of the drive signal ComBa are denoted by the reference sign “−2”.

The drive signal ComBa-1 is an example in which the electrical potential change rate of the second damping contraction element c2 is adjusted. In the example of the drive signal ComBa-1, the control circuit 21 sets the period of the second damping contraction element c2-1 included in the drive signal ComBa-1 to be longer than the period of the second damping contraction element c2, and thus sets the absolute value of the electrical potential change rate of the second damping contraction element c2-1 to be less than the absolute value of the electrical potential change rate of the second damping contraction element c2. Further, in the drive signal ComBa-1, the period of the end electrical potential maintained element aeBa-1 is set to be shorter than the period of the end electrical potential maintained element aeBa by the amount by which the period of the second damping contraction element c2-1 is set to be longer than the period of the second damping contraction element c2. As a result of reducing the absolute value of the electrical potential change rate of the second damping contraction element c2-1, as is understood from FIG. 17, the adjustment time interval tB-1 in the drive signal ComBa-1 is closer to the maximum damping time interval than the adjustment time interval tB is, and it is possible to reduce the effect of the residual vibration on the next ejection pulse PD. In step S24, the control circuit 21 sets the time of the ending edge of the second damping contraction element c2-1 to be later than the time of the ending edge of the second damping contraction element c2 in the waveform information CI. When the adjustment time interval tB is set to be longer than the maximum damping time interval, the control circuit 21 sets the period of the second damping contraction element c2-1 included in the drive signal ComBa-1 to be shorter than the period of the second damping contraction element c2, and sets the period of the end electrical potential maintained element aeBa-1 to be longer than the period of the end electrical potential maintained element aeBa.

The drive signal ComBa-2 is an example in which the period of the third damping maintained element pwh3 is adjusted. In the example of the drive signal ComBa-2, the control circuit 21 sets the period of the third damping maintained element pwh3-2 included in the drive signal ComBa-2 to be shorter than the period of the third damping maintained element pwh3. Further, in the drive signal ComBa-2, the period of the end electrical potential maintained element aeBa-2 is set to be longer than the period of the end electrical potential maintained element aeBa by the amount by which the period of the third damping maintained element pwh3-2 is set to be shorter than the period of the third damping maintained element pwh3. As a result of setting the period of the third damping maintained element pwh3-2 to be shorter than the period of the third damping maintained element pwh3, as is understood from FIG. 18, the adjustment time interval tB-2 in the drive signal ComBa-2 is more different from the maximum damping time interval than the adjustment time interval tB is, and thus it is possible to increase the effect of the residual vibration on the next ejection pulse PD. When the adjustment time interval tB is set to be longer than the maximum damping time interval, the control circuit 21 sets the period of the third damping maintained element pwh3-2 included in the drive signal ComBa-2 to be longer than the period of the third damping maintained element pwh3, and sets the period of the end electrical potential maintained element aeBa-1 to be shorter than the period of the end electrical potential maintained element aeBa.

### A9: Summary of First Embodiment

As described above, the liquid ejecting apparatus 100 according to the first embodiment includes the ejection section D including the nozzle N from which liquid is ejected, the pressure chamber C communicating with the nozzle N, and the drive element E that is driven to change pressure applied to the liquid in the pressure chamber C according to the supplied drive signal Com, and the drive signal generating circuit 24 that generates the drive signal Com. The drive signal Com includes one ejection pulse PD in one drive period Tu. The one ejection pulse PD includes an ejection waveform element DR that changes the pressure applied to the liquid in the pressure chamber C such that the liquid is ejected from the nozzle N, and a residual vibration suppression element ED that reduces the change in the pressure applied to the liquid in the pressure chamber C according to the natural vibration period Tc of the ejection section D, while the change in the pressure remains after the liquid is ejected from the nozzle N. The control circuit 21 of the liquid ejecting apparatus 100 adjusts the residual vibration suppression element ED of the one ejection pulse PD to correct the weight of droplets that are continuously ejected from the nozzle N when the drive signal Com is supplied to the drive element E over a period corresponding to two or more drive periods Tu.

According to the first embodiment, by adjusting the residual vibration suppression element ED, it is possible to control the magnitude of the residual vibration that affects an ejection pulse PD subsequent to the ejection pulse PD including the residual vibration suppression element ED even in the high-frequency driving, and thus it is possible to correct the amount of liquid to be ejected based on the subsequent ejection pulse PD.

When the drive signal Com is a drive signal ComA among the drive signals ComA, the ejection waveform element DRAa of the one ejection pulse PAa includes the ejection element c1 that contracts the pressure chamber C to cause a droplet to be ejected from the nozzle N. The residual vibration suppression element ED of the one ejection pulse PD includes the first damping maintained element pwh2 that maintains the constant electrical potential from the ending edge of the ejection element c1, and the first damping expansion element d2 that starts changing the electrical potential from the ending edge of the first damping maintained element pwh2 to expand the pressure chamber C. The control circuit 21 adjusts at least one of the period of the first damping maintained element pwh2 or the electrical potential change rate of the first damping expansion element d2 in the residual vibration suppression element ED of the one ejection pulse PD to correct the weight of droplets that are continuously ejected from the nozzle N when the drive signal ComA is supplied to the drive element E over the period corresponding to the two or more drive periods Tu.

According to the first embodiment, by adjusting at least one of the period of the first damping maintained element pwh2 or the electrical potential change rate of the first damping expansion element d2, the weight of a droplet in the large amount can be corrected.

When the natural vibration period of the ejection section D is Tc, the adjustment time interval tA from the center time of the period of the ejection element c1 to the center time of the first damping expansion element d2 is greater than 0.5Tc and less than 1.5Tc.

If the adjustment time interval tA is less than or equal to 0.5Tc, since a large residual vibration remains, ejection based on the next ejection pulse PD is unstable. On the other hand, if the adjustment time interval tB is greater than or equal to 1.5Tc, the period of the ejection pulse PD is increased, and may be longer than the drive period Tu. If the drive period Tu is lengthened, the high-frequency driving is difficult. According to the above description, in the mode in which the adjustment time interval tA is greater than 0.5Tc and less than 1.5Tc, the high-frequency driving is facilitated while suppressing the instability of the ejection based on the next ejection pulse PD.

When the drive signal Com is a drive signal ComB among the drive signals ComB, the ejection waveform element DRBa of the one ejection pulse PBa includes the contraction element c3 that contracts the pressure chamber C to causes the liquid column DC to protrude from the nozzle N, and the division element d5 that expands the pressure chamber C after the contraction element c3 to divide the liquid column DC into a plurality of portions. The residual vibration suppression element EDBa of the one ejection pulse PBa includes the third damping maintained element pwh3 that maintains the constant electrical potential from the ending edge of the division element d5, and the second damping contraction element c2 that contracts the pressure chamber C from the ending edge of the third damping maintained element pwh3. The control circuit 21 adjusts at least one of the period of the third damping maintained element pwh3 or the electrical potential change rate of the second damping contraction element c2 in the residual vibration suppression element ED of the one ejection pulse PD to correct the weight of droplets that are continuously ejected from the nozzle N when the drive signal ComB is supplied to the drive element E over a period of two or more drive periods Tu.

According to the first embodiment, by adjusting at least one of the period of the third damping maintained element pwh3 or the second damping contraction element c2, the weight of a droplet in the small amount can be corrected.

The drive signal Com having the ejection pulse PD includes, in one drive period Tu, the ejection pulse PD, a start electrical potential maintained element as that maintains the reference electrical potential V0 from the start point of the one drive period Tu to the start of the ejection waveform element DR of the one ejection pulse PD, and an end electrical potential maintained element ae that maintains the reference electrical potential V0 from the end point of the residual vibration suppression element ED of the one ejection pulse PD to the end point of the one drive period Tu. When the natural vibration period of the ejection section D is Tc, the length of the one drive period Tu satisfies Expression (1).

When the length of the drive period Tu satisfies Expression (1), the amount Iw of liquid to be ejected can be easily adjusted as compared to an aspect in which the length of the drive period Tu does not satisfy Expression (1).

In addition, when the drive signal Com is a drive signal ComA among the drive signals ComA, the ejection waveform element DR of the one ejection pulse PAa includes the ejection element c1 that contracts the pressure chamber C to cause a droplet to be ejected from the nozzle N. The residual vibration suppression element ED of the one ejection pulse PAa includes the first damping maintained element pwh2 that maintains the constant electrical potential from the ending edge of the ejection element c1, and the first damping expansion element d2 that starts changing the potential change from the ending edge of the first damping maintained element pwh2 to expand the pressure chamber C. When the adjustment time interval tA from the center time of the period of the ejection element c1 to the center time of the period of the first damping expansion element d2 is greater than 0.5Tc and less than 1.5Tc, where Tc is the natural vibration period of the ejection section D, at least one of the period of the first damping maintained element pwh2 or the electrical potential change rate of the first damping expansion element d2 is adjusted to correct the weight of droplets that are continuously ejected from the nozzle N when the drive signal ComA is supplied to the drive element E over the period corresponding to the two or more drive periods Tu.

According to the first embodiment, it is possible to correct the weight of a droplet in the large amount while suppressing the instability of ejection based on the next ejection pulse PD and maintaining a state in which the high-frequency driving is facilitated.

In addition, when the drive signal Com is a drive signal ComA among the drive signals ComA, and the drive signal ComA is supplied to the drive element E over a period corresponding to two or more drive periods Tu to reduce the weight of droplets to be continuously ejected from the nozzle N, the control circuit 21 adjusts the adjustment time interval tA to a value closer to the natural vibration period Tc than the current value of the adjustment time interval tA before the adjustment is. On the other hand, when the drive signal ComA is to be supplied to the drive element E over a period of two or more drive periods Tu to increase the weight of droplets to be continuously ejected from the nozzle N, the control circuit 21 adjusts the adjustment time interval tA to a value more different from the natural vibration period Tc than the current value of the adjustment time interval tA before the adjustment is.

According to the first embodiment, when the drive signal ComA is to be supplied to reduce the weight of droplets to be continuously ejected from the nozzle N, it is possible to efficiently correct the weight of the droplets in the large amount, as compared to a mode in which the weight of droplets in the large amount is corrected while the adjustment time interval tA is finely adjusted.

### B1: Second Embodiment

The ejection pulse PD for ejecting a droplet in the large amount is not limited to the ejection pulse PAa described in the first embodiment. A second embodiment will be described below.

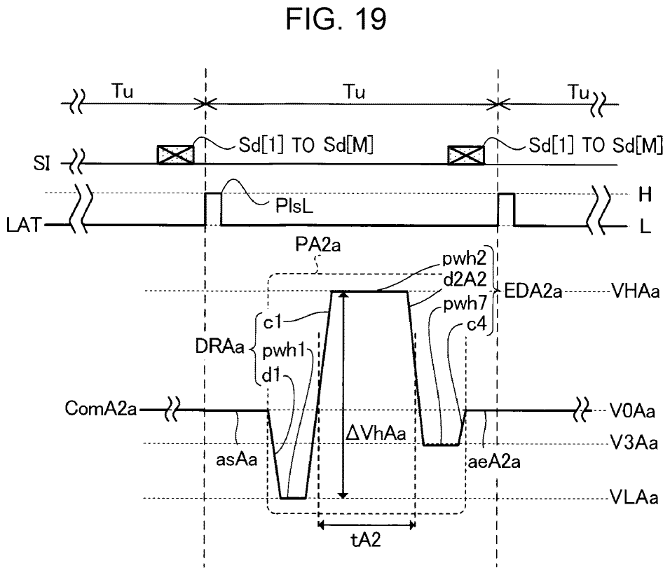

FIG. 19 is a diagram illustrating a drive signal Com in the second embodiment. In the second embodiment, the drive signal generating circuit 24 generates a drive signal ComA2a instead of the drive signal ComAa, generates a drive signal ComA2b instead of the drive signal ComAb, and generates a drive signal ComA2c instead of the drive signal ComAc. The drive signal ComA2a, the drive signal ComA2b, and the drive signal ComA2c may be referred to as drive signals ComA2 without being distinguished from each other. FIG. 19 does not illustrate the drive signals ComB and the drive signals ComC.

As illustrated in FIG. 19, the drive signal ComA2a is different from the drive signal ComA in that the drive signal ComA2a includes an ejection pulse PA2a for forming a large dot instead of the ejection pulse PAa, and includes an end electrical potential maintained element aeA2a instead of the end electrical potential maintained element aeAa. The ejection pulse PA2a is different from the ejection pulse PAa in that the ejection pulse PA2a includes a residual vibration suppression element EDA2a instead of the residual vibration suppression element EDAa. The residual vibration suppression element EDA2a is different from the residual vibration suppression element EDAa in that the residual vibration suppression element EDA2a includes a first damping expansion element d2A2 instead of the first damping expansion element d2 and further includes a second damping maintained element pwh7 and a first damping contraction element c4.

The first damping expansion element d2A2 is different from the first damping expansion element d2 in that the first damping expansion element d2A2 changes the electrical potential from the highest electrical potential VHAa to a reference electrical potential V3Aa. The reference electrical potential V3Aa is between the lowest electrical potential VLAa and the reference electrical potential VOAa. The ending edge of the first damping expansion element d2A2 is coupled to the starting edge of the second damping maintained element pwh7. The second damping maintained element pwh7 maintains the electrical potential of the ending edge of the first damping expansion element d2. The ending edge of the second damping maintained element pwh7 is coupled to the starting edge of the first damping contraction element c4. The first damping contraction element c4 changes to the reference electrical potential VOAa from the ending edge of the second damping maintained element pwh7.

### B2: Process of Correcting Amount of Liquid to be Ejected in Second Embodiment

In the second embodiment, as in the first embodiment, the control circuit 21 executes a process of correcting the amount of liquid to be ejected as illustrated in FIG. 14. In the second embodiment, the adjustment time interval t in step S24 and step S26 is an adjustment time interval tA2 illustrated in FIG. 19. The adjustment time interval tA2 is from the center time of the period of the ejection element c1 to the center time of the period of the first damping expansion element d2A2 in the drive signal ComA2a. Further, in the second embodiment, as in the first embodiment, the control circuit 21 sets the adjustment time interval tA2 to be greater than 0.5Tc and less than 1.5Tc. Even when the adjustment target drive signal Com-Adj is the drive signal ComA2b or the drive signal ComA2c, the adjustment time interval tA2 is from the center time of the period of the ejection element c1 to the center time of the period of the first damping expansion element d2. In the second embodiment, the adjustment time interval tA2 is an example of the “first time interval”.

In the second embodiment, as in the first embodiment, the control circuit 21 adjusts at least one of the period of the first damping maintained element pwh2 or the electrical potential change rate of the first damping expansion element d2A2 in step S24 and step S26.

As described above, according to the second embodiment, as in the first embodiment, the weight of a droplet in the large amount can be corrected even in the high-frequency driving.

### C: Modifications

Each of the above-described embodiments can be variously modified. Specific modifications that can be applied to each of the above-described embodiments will be described below. Two or more aspects freely selected from the following examples can be appropriately combined within a range in which the two or more aspects do not contradict each other.

### C1: First Modification

In the first embodiment, in the adjustment of the residual vibration suppression element ED of the drive signal ComA, the control circuit 21 adjusts at least one of the period of the first damping maintained element pwh2 or the electrical potential change rate of the first damping expansion element d2. However, the present disclosure is not limited thereto. For example, the control circuit 21 may adjust at least one of the period of the first damping maintained element pwh2, the electrical potential change rate of the first damping expansion element d2, or the electrical potential change range of the first damping expansion element d2. In the adjustment of the electrical potential change range of the first damping expansion element d2, the control circuit 21 adjusts one or both of the electrical potentials of the starting edge and ending edge of the first damping expansion element d2.

In the adjustment of the electrical potential of the starting edge of the first damping expansion element d2, the control circuit 21 matches the highest electrical potential VHAa maintained by the first damping maintained element pwh2 and the electrical potential of the ending edge of the ejection element c1 with the electrical potential of the starting edge of the first damping expansion element d2 after the adjustment. Further, as is understood from FIG. 8, when the electrical potential of the starting edge of the first damping expansion element d2 is adjusted, the electrical potential difference ΔVh is also necessarily changed. As described above, in the first modification, the electrical potential difference ΔVh may be changed as a result of adjusting the residual vibration suppression element ED.

Further, in the adjustment of the terminal potential of the first damping expansion element d2, the control circuit 21 matches the reference electrical potential VOAa maintained by the end electrical potential maintained element aeAa with the electrical potential of the ending edge of the first damping expansion element d2 after the adjustment. In this way, in the first modification, as a result of adjusting the residual vibration suppression element ED of a certain drive signal Com, the reference electrical potential V0 may be different from the reference electrical potential V0 of another drive signal Com. Alternatively, in the adjustment of the electrical potential of the ending edge of the first damping expansion element d2 to an electrical potential lower than the reference electrical potential VOAa, the control circuit 21 may add an element that changes from the electrical potential of the ending edge of the first damping expansion element d2 to the reference electrical potential VOAa after the first damping expansion element d2, and forms a waveform shape such as the ejection pulse PA2a illustrated in FIG. 19.

Similarly, in the adjustment of the residual vibration suppression element ED of the drive signal ComB, the control circuit 21 adjusts at least one of the period of the third damping maintained element pwh3 or the electrical potential change rate of the second damping contraction element c2. However, the present disclosure is not limited thereto. For example, the control circuit 21 may adjust at least one of the period of the third damping maintained element pwh3, the electrical potential change rate of the second damping contraction element c2, or the electrical potential change range of the second damping contraction element c2. In the adjustment of the electrical potential change range of the second damping contraction element c2, the control circuit 21 adjusts one or both of the electrical potentials of the starting edge and the ending edge of the second damping contraction element c2.

In the adjustment of the electrical potential of the starting edge of the second damping contraction element c2, the control circuit 21 matches the electrical potential V2Ba maintained by the third damping maintained element pwh3 and the electrical potential of the ending edge of the division element d5 with the electrical potential of the starting edge of the second damping contraction element c2 after the adjustment. Further, in the adjustment of the electrical potential of the ending edge of the second damping contraction element c2, the control circuit 21 matches the highest electrical potential VHBa maintained by the fourth damping maintained element pwh4 and the electrical potential of the ending edge of the second damping expansion element d3 with the electrical potential of the ending edge of the second damping contraction element c2 after the adjustment.

### C2: Second Modification

In the second embodiment, in the adjustment of the residual vibration suppression element ED of the drive signal ComA2, the control circuit 21 adjusts at least one of the period of the first damping maintained element pwh2 or the electrical potential change rate of the first damping expansion element d2A2. However, the present disclosure is not limited thereto. For example, the control circuit 21 may adjust at least one of the period of the first damping maintained element pwh2, the electrical potential change rate of the first damping expansion element d2A2, or the electrical potential change range of the first damping expansion element d2A2.

### C3: Third Modification

Further, in the second embodiment and the modification based on the second embodiment, in the adjustment of the residual vibration suppression element ED of the drive signal ComA2, the control circuit 21 may adjust at least one of the period of the first damping maintained element pwh2, the electrical potential change rate of the first damping expansion element d2A2, the electrical potential change range of the first damping expansion element d2A2, the period of the second damping maintained element pwh7, the electrical potential change rate of the first damping contraction element c4, or the electrical potential change range of the first damping contraction element c4.

In addition, in a third modification, the adjustment time interval tA2 is greater than 0.5Tc and less than 1.5Tc as in each of the above-described aspects.

As described above, according to the third modification, as in the second embodiment, the weight of a droplet in the large amount can be corrected even in the high-frequency driving. Further, in the third modification, since the number of adjustable elements in the residual vibration suppression element ED of the drive signal ComA is greater than that in the second embodiment, it is possible to improve the degree of freedom of the setting of the drive signal ComA.

### C4: Fourth Modification

In the first modification, in the adjustment of the residual vibration suppression element ED of the drive signal ComB, the control circuit 21 adjusts at least one of the period of the third damping maintained element pwh3, the electrical potential change rate of the second damping contraction element c2, or the electrical potential change range of the second damping contraction element c2. However, the present disclosure is not limited thereto. For example, the control circuit 21 may adjust at least one of the period of the third damping maintained element pwh3, the electrical potential change rate of the second damping contraction element c2, the electrical potential change range of the second damping contraction element c2, the period of the fourth damping maintained element pwh4, the electrical potential change rate of the second damping expansion element d3, or the electrical potential change range of the second damping expansion element d3. In this case as well, the relationship between the period of the third damping maintained element pwh3, the electrical potential change rate of the second damping contraction element c2, the electrical potential change range of the second damping contraction element c2, the period of the fourth damping maintained element pwh4, the electrical potential change rate of the second damping expansion element d3, the electrical potential change range of the second damping expansion element d3, a change in the electrical potential change range of the second damping expansion element d3, and a change in residual vibration is confirmed in advance through an experiment or the like, and each of the elements is adjusted based on correction to increase the amount of liquid to be ejected and correction to reduce the amount of liquid to be ejected. In the adjustment of the electrical potential change rate of the second damping expansion element d3, the control circuit 21 adjusts at least one of the electrical potentials of the starting edge or the ending edge of the second damping expansion element d3 and the period of the second damping expansion element d3. In the adjustment of the electrical potential change range of the second damping expansion element d3, at least one of the electrical potentials of the starting edge or the ending edge of the second damping expansion element d3 is adjusted.

As described above, according to the fourth modification, as in the first modification, the weight of a droplet in the small amount can be corrected even in the high-frequency driving. Further, in the fourth modification, since the number of adjustable elements in the residual vibration suppression element ED of the drive signal ComB is greater than that in the first modification, it is possible to improve the degree of freedom of the setting of the drive signal ComB.

### C5: Fifth Modification

In each of the aspects described above, each of the drive signals Com has one ejection pulse PD in one drive period Tu. However, the present disclosure is not limited thereto. For example, the drive signal Com may have two or more ejection pulses PD in one drive period Tu. A fifth modification will be described below.

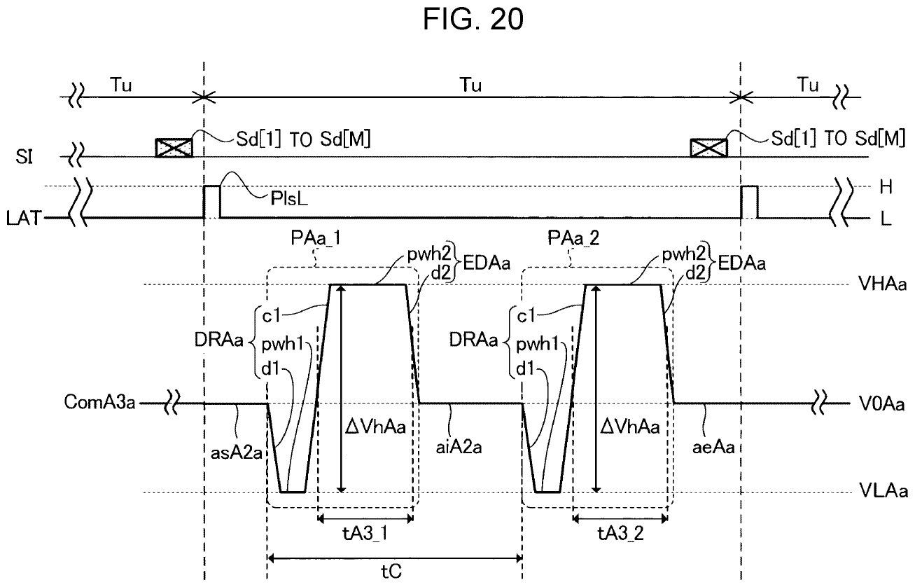

FIG. 20 is a diagram illustrating a drive signal Com in the fifth modification. In the fifth modification, the drive signal generating circuit 24 generates a drive signal ComA3a instead of the drive signal ComAa, generates a drive signal ComA3b instead of the drive signal ComAb, and generates a drive signal ComA3c instead of the drive signal ComAc. Hereinafter, the drive signal ComA3a, the drive signal ComA3b, and the drive signal ComA3c may be referred to as drive signals ComA3 without being distinguished from each other. FIG. 20 does not illustrate the drive signals ComB and the drive signals ComC.

As illustrated in FIG. 20, the drive signal ComA3a includes a start electrical potential maintained element asA2a, an ejection pulse PAa_1, a coupling element aiA2a, an ejection pulse PAa_2, and an end electrical potential maintained element aeA2a in this order in one drive period Tu. As described above, two ejection pulses PD, that is, the ejection pulse PAa_1 and the ejection pulse PAa_2 are provided in one drive period Tu. The two ejection pulses PD are an example of “at least one ejection pulse”.

The ejection pulse PAa_1 and the ejection pulse PAa_2 have the same shape as the ejection pulse PAa. In FIG. 20, for simplification of description, the ejection pulse PAa_1 and the ejection pulse PAa_2 are the ejection pulses PD having the same shape, but may be ejection pulses PD having different shapes.

The start electrical potential maintained element asA2a maintains the reference electrical potential VOAa from the start of the one drive period Tu to the start of the ejection waveform element DRAa of the ejection pulse PAa_1. The coupling element aiA2a is coupled while maintaining the reference electrical potential VOAa from the end point of the residual vibration suppression element EDAa of the ejection pulse PAa_1 to the start of the ejection waveform element DRAa of the ejection pulse PAa_2. The end electrical potential maintained element aeA2a maintains the reference electrical potential VOAa from the end of the ejection pulse PAa_2 to the end of one drive period Tu.

The start electrical potential maintained element asA2a is an example of a “start electrical potential maintained element that maintains an electrical potential from start of the drive period to start of an ejection waveform element of a first ejection pulse among two or more ejection pulses”. The coupling element aiA2a is an example of a “coupling element that is coupled while maintaining an electrical potential from an end point of a residual vibration suppression element of a preceding ejection pulse out of two consecutive ejection pulses among the two or more ejection pulses to start of an ejection waveform element of a subsequent ejection pulse out of the two consecutive ejection pulses”. The end electrical potential maintained element aeA2a is an example of an “end electrical potential maintained element that maintains an electrical potential from an end point of a residual vibration suppression element of a last ejection pulse among the two or more ejection pulses to end of the one drive period”.

A period tC illustrated in FIG. 20 satisfies the following Expression (2).

$$( 0.5 \times n - 0.2 ) \times T c < t C < ( 0.5 \times n + 02 ) \times Tc \qquad ( 2 )$$

The period tC is from the start of the ejection waveform element DRAa of the ejection pulse PAa_1 to the start of the ejection waveform element DRAa of the ejection pulse PAa_2. The period tC is an example of a “period from start of an ejection waveform element of the preceding ejection pulse to the start of the ejection waveform element of the subsequent ejection pulse”. Since the period tC satisfies Expression (2), it is possible to easily adjust the amount Iw of liquid to be ejected, as compared to an aspect in which the period tC does not satisfy Expression (2).

Also in the fifth modification, as in the first embodiment, when the result of the determination in step S22 is affirmative, the control circuit 21 adjusts the residual vibration suppression elements ED of the ejection pulse PAa_1 and the ejection pulse PAa_2 such that an adjustment time interval tA3_1 and an adjustment time interval tA3_2 are set to values closer to the natural vibration period Tc than the current values of the adjustment time intervals tA3_1 and tA3_2 before the adjustment are in step S24. The adjustment time interval tA3_1 is from the center time of the period of the ejection element c1 to the center time of the period of the first damping expansion element d2 in the ejection pulse PAa_1. The adjustment time interval tA3_2 is from the center time of the period of the ejection element c1 to the center time of the period of the first damping expansion element d2 in the ejection pulse PAa_2. When the result of the determination in step S22 is negative, the control circuit 21 adjusts the residual vibration suppression elements ED of the ejection pulse PAa_1 and the ejection pulse PAa_2 such that the adjustment time interval tA3_1 and the adjustment time interval tA3_2 are set to values more different from the natural vibration period Tc than the current values of the adjustment time intervals tA3_1 and tA3_2 before the adjustment are in step S26.

Further, the control circuit 21 sets the adjustment time interval tA3_1 and the adjustment time interval tA3_2 to be greater than 0.5Tc and less than 1.5Tc. By setting the adjustment time interval tA3_1 and the adjustment time interval tA3_2 to be greater than 0.5Tc and less than 1.5Tc, the high-frequency driving is facilitated while suppressing the instability of ejection based on the next ejection pulse PD.

### C6: Sixth Modification

In the fifth modification, each of the drive signals ComA includes one ejection pulse PD in one drive period Tu, but each of the drive signals ComB may include two ejection pulses PD in one drive period Tu. A sixth modification will be described below.

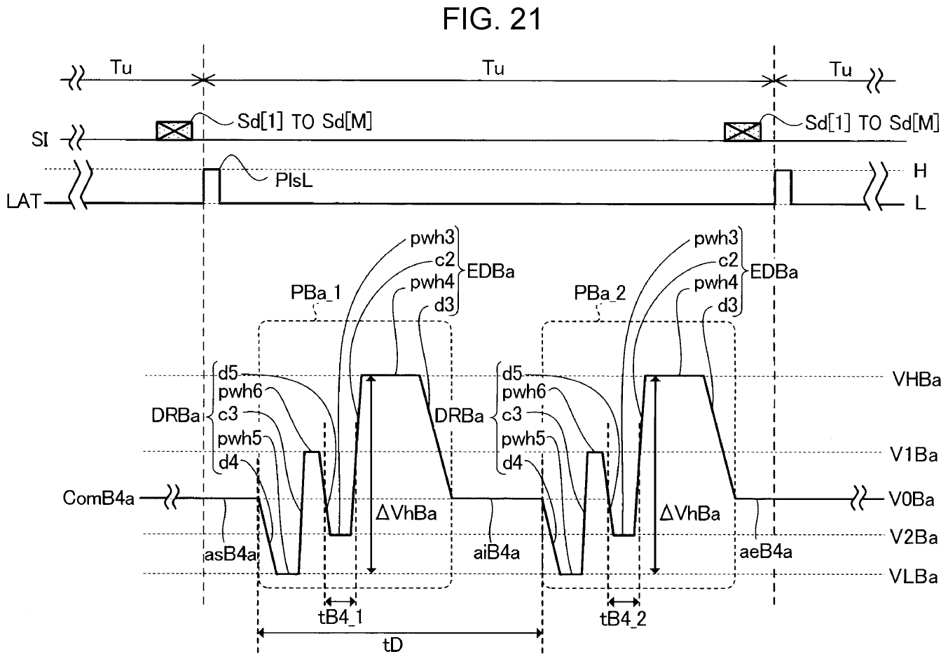

FIG. 21 is a diagram illustrating a drive signal Com in the sixth modification. In the sixth modification, the drive signal generating circuit 24 generates a drive signal ComB4a instead of the drive signal ComBa, generates a drive signal ComB4b instead of the drive signal ComBb, and generates a drive signal ComB4c instead of the drive signal ComBc. Hereinafter, the drive signal ComB4a, the drive signal ComB4b, and the drive signal ComB4c may be referred to as drive signals ComB4 without being distinguished from each other. FIG. 21 does not illustrate the drive signals ComA and the drive signals ComC.

As illustrated in FIG. 21, the drive signal ComB4a includes a start electrical potential maintained element asB4a, an ejection pulse PBa_1, a coupling element aiB4a, an ejection pulse PBa_2, and an end electrical potential maintained element aeB4a in this order in one drive period Tu. As described above, two ejection pulses PD, that is, the ejection pulse PBa_1 and the ejection pulse PBa_2 are provided in the one drive period Tu. The two ejection pulses PD are an example of “at least one ejection pulse”.

The ejection pulse PBa_1 and the ejection pulse PBa_2 have the same shape as the ejection pulse PBa. In FIG. 21, in order to simplify the description, the ejection pulse PBa_1 and the ejection pulse PBa_2 are the ejection pulses PD having the same shape, but may be ejection pulses PD having different shapes.

The start electrical potential maintained element asB4a maintains the reference electrical potential VOBa from the start of the one drive period Tu to the start of the ejection waveform element DRBa of the ejection pulse PBa_1. The coupling element aiB4a is coupled while maintaining the reference electrical potential VOBa from the end point of the residual vibration suppression element ED of the ejection pulse PBa_1 to the start of the ejection waveform element DRBa of the ejection pulse PBa_2. The end electrical potential maintained element aeB4a maintains the reference electrical potential VOBa from the end of the ejection pulse PBa_2 to the end of the one drive period Tu.

The start electrical potential maintained element asB4a is an example of a “start electrical potential maintained element that maintains an electrical potential from start of the drive period to start of an ejection waveform element of a first ejection pulse among two or more ejection pulses”. The coupling element aiB4a is an example of a “coupling element that is coupled while maintaining an electrical potential from an end point of a residual vibration suppression element of a preceding ejection pulse out of two consecutive ejection pulses among the two or more ejection pulses to start of an ejection waveform element of a subsequent ejection pulse out of the two consecutive ejection pulses”. The end electrical potential maintained element aeB4a is an example of a “residual vibration suppression element of a last ejection pulse among the two or more ejection pulses”.

A period tD illustrated in FIG. 21 satisfies the following Expression (3).

$$( 0.5 \times n - 0.2 ) \times T c < t D < ( 0.5 \times n + 0.2 ) \times Tc \qquad ( 3 )$$

The period tD is from the start of the ejection waveform element DRBa of the ejection pulse PBa_1 to the start of the ejection waveform element DRBa of the ejection pulse PBa_2. The period tD is an example of a “period from start of an ejection waveform element of the preceding ejection pulse to the start of the ejection waveform element of the subsequent ejection pulse”. Since the period tD satisfies Expression (3), it is possible to easily adjust the amount Iw of liquid to be ejected, as compared to an aspect in which the period tC does not satisfy Expression (3).

Also in the sixth modification, as in the first embodiment, when the result of the determination in step S22 is affirmative, the control circuit 21 adjusts the residual vibration suppression elements ED of the ejection pulse PBa_1 and the ejection pulse PBa_2 such that an adjustment time interval tB4_1 and an adjustment time interval tB4_2 are set to values closer to the maximum damping time interval than the current values of the adjustment time intervals tB4_1 and tB4_2 before the adjustment are in step S24. When the result of the determination in step S22 is negative, the control circuit 21 adjusts the residual vibration suppression elements ED of the ejection pulse PBa_1 and the ejection pulse PBa_2 such that the adjustment time interval tB4_1 and the adjustment time interval tB4_2 are set to values more different from the maximum damping time interval than the current values of the adjustment time intervals tB4_1 and tB4_2 before the adjustment are in step S26.

### C7. Seventh Modification

In each of the above-described aspects, the adjustment time intervals tA are set to be greater than 0.5Tc and less than 1.5Tc, but are not limited thereto. For example, in a case where the viscosity of the liquid is high, since the residual vibration is rapidly attenuated, the adjustment time intervals tA may be less than or equal to 0.5Tc. If the high-frequency driving is not required, the adjustment time intervals tA may be greater than or equal to 1.5Tc.

### C8: Eighth Modification

In each of the above-described aspects, the drive period Tu satisfies Expression (1), but may not satisfy Expression (1). In a case where the drive period Tu is not (0.5×n−0.25) times or (0.5×n+0.25) times, the amount of deviation in the amount Iw of liquid to be ejected is less than that in the aspect in which Expression (1) is satisfied, but the correction of the amount Iw of liquid to be ejected is possible.

### C9: Ninth Modification

In each of the aspects described above, the liquid ejecting apparatus 100 is a line type liquid ejecting apparatus in which the plurality of nozzles N are distributed over the entire width of the medium PP, but the present disclosure is also applied to a serial type liquid ejecting apparatus in which the carriage 501 on which the liquid ejecting head 50 is mounted reciprocates.

### C10: Other Modifications

The liquid ejecting apparatus 100 exemplified in each of the aspects described above may be employed in various apparatuses such as a facsimile apparatus and a copy machine in addition to an apparatus dedicated to printing, and the application of the present disclosure is not particularly limited. However, the application of the liquid ejecting apparatus is not limited to printing. For example, a liquid ejecting apparatus that ejects a solution of a coloring material is used as a manufacturing apparatus that forms a color filter for a display device such as a liquid crystal display panel. In addition, a liquid ejecting apparatus that ejects a solution of a conductive material is used as a manufacturing apparatus that forms wiring or an electrode for a wiring substrate. Further, a liquid ejecting apparatus that ejects a solution of an organic substance related to a living body is used, for example, as a manufacturing apparatus that manufactures a biochip.

What is claimed is:

1. A method of driving a liquid ejecting apparatus including
an ejection section including a nozzle from which a droplet is ejected, a pressure chamber communicating with the nozzle, and a drive element that is configured to be driven to change pressure applied to liquid in the pressure chamber according to a supplied drive signal, and
a drive signal generating circuit that is configured to generate the drive signal, wherein
the drive signal includes at least one ejection pulse in a drive period,
the at least one ejection pulse includes
an ejection waveform element that changes an electrical potential to change the pressure applied to the liquid in the pressure chamber such that a droplet is ejected from the nozzle, and
a residual vibration suppression element that changes an electrical potential to reduce the change in the pressure applied to the liquid in the pressure chamber, the change in the pressure remaining after the ejection of the droplet from the nozzle according to a natural vibration period of the ejection section,
the method comprising adjusting the residual vibration suppression element of the at least one ejection pulse to correct a weight of droplets that are continuously ejected from the nozzle when the drive signal is supplied to the drive element over a period corresponding to two or more drive periods.

2. The driving method according to claim 1, wherein
the ejection waveform element of the at least one ejection pulse includes an ejection element that changes an electrical potential to contract the pressure chamber to eject a droplet from the nozzle,
the residual vibration suppression element of the at least one ejection pulse includes a first damping maintained element that maintains a constant electrical potential from an ending edge of the ejection element, and a first damping expansion element that starts changing an electrical potential from an ending edge of the first damping maintained element to expand the pressure chamber, and
the weight of the droplets to be continuously ejected from the nozzle when the drive signal is supplied to the drive element over the period corresponding to the two or more drive periods is corrected by adjusting at least one of a period of the first damping maintained element, an electrical potential change rate of the first damping expansion element, or an electrical potential change range of the first damping expansion element in the residual vibration suppression element of the at least one ejection pulse.

3. The driving method according to claim 2, wherein
when the natural vibration period of the ejection section is Tc,
a first time interval from a center time of a period of the ejection element to a center time of the first damping expansion element is greater than 0.5Tc and less than 1.5Tc.

4. The driving method according to claim 1, wherein
the ejection waveform element of the at least one ejection pulse includes an ejection element that changes an electrical potential to contract the pressure chamber to eject a droplet from the nozzle,
the residual vibration suppression element of the at least one ejection pulse includes a first damping maintained element that maintains a constant electrical potential from an ending edge of the ejection element, a first damping expansion element that starts changing an electrical potential from an ending edge of the first damping maintained element to expand the pressure chamber, a second damping maintained element that maintains an electrical potential of an ending edge of the first damping expansion element, and a first damping contraction element that changes an electrical potential to a first electrical potential from an ending edge of the second damping maintained element, and
the weight of the droplets to be continuously ejected from the nozzle when the drive signal is supplied to the drive element over the period corresponding to the two or more drive periods is corrected by adjusting at least one of a period of the first damping maintained element, an electrical potential change rate of the first damping expansion element, an electrical potential change range of the first damping expansion element, a period of the second damping maintained element, an electrical potential change rate of the first damping contraction element, or an electrical potential change range of the first damping contraction element in the residual vibration suppression element of the at least one ejection pulse.

5. The driving method according to claim 4, wherein
when the natural vibration period of the ejection section is Tc,
a first time interval from a center time of a period of the ejection element to a center time of the first damping expansion element is greater than 0.5Tc and less than 1.5Tc.

6. The driving method according to claim 1, wherein
the ejection waveform element of the at least one ejection pulse includes a contraction element that changes an electrical potential to contract the pressure chamber to cause a liquid column to protrude from the nozzle, and a division element that changes an electrical potential to expand the pressure chamber after the contraction element to divide the liquid column into a plurality of portions,
the residual vibration suppression element of the at least one ejection pulse includes a third damping maintained element that maintains a constant electrical potential from an ending edge of the division element, and a second damping contraction element that changes an electrical potential from an ending edge of the third damping maintained element to contract the pressure chamber, and
the weight of the droplets to be continuously ejected from the nozzle when the drive signal is supplied to the drive element over the period corresponding to the two or more drive periods is corrected by adjusting at least one of a period of the third damping maintained element, an electrical potential change rate of the second damping contraction element, or an electrical potential change range of the second damping contraction element in the residual vibration suppression element of the at least one ejection pulse.

7. The driving method according to claim 1, wherein
the ejection waveform element of the at least one ejection pulse includes a contraction element that changes an electrical potential to contract the pressure chamber to cause a liquid column to protrude from the nozzle, and a division element that changes an electrical potential to expand the pressure chamber after the contraction element to divide the liquid column into a plurality of portions,
the residual vibration suppression element of the at least one ejection pulse includes a third damping maintained element that maintains a constant electrical potential from an ending edge of the division element, a second damping contraction element that changes an electrical potential from an ending edge of the third damping maintained element to contract the pressure chamber, a fourth damping maintained element that maintains a constant electrical potential from an ending edge of the second damping contraction element, and a second damping expansion element that changes an electrical potential from an ending edge of the fourth damping maintained element to expand the pressure chamber, and
the weight of the droplets to be continuously ejected from the nozzle when the drive signal is supplied to the drive element over the period corresponding to the two or more drive periods is corrected by adjusting at least one of a period of the third damping maintained element, an electrical potential change rate of the second damping contraction element, an electrical potential change range of the second damping contraction element, a period of the fourth damping maintained element, an electrical potential change rate of the second damping expansion element, or an electrical potential change range of the second damping expansion element in the residual vibration suppression element of the at least one ejection pulse.

8. The driving method according to claim 1, wherein
the drive signal includes, in the drive period,
an ejection pulse,
a start electrical potential maintained element that maintains a first electrical potential from a start point of the drive period to start of the ejection waveform element of the ejection pulse, and
an end electrical potential maintained element that maintains the first electrical potential from an end point of the residual vibration suppression element of the ejection pulse to an end point of the drive period, and
when the natural vibration period of the ejection section is Tc, and a length of the drive period is Tu,
Tu satisfies expression (1):
$$( 0.5 \times n - 02 ) \times T c < T u < ( 0.5 \times n + 0.2 ) \times Tc \qquad ( 1 )$$
where n is an integer greater than or equal to 1.

9. The driving method according to claim 1, wherein
the ejection waveform element of the at least one ejection pulse includes an ejection element that changes an electrical potential to contract the pressure chamber to eject a droplet from the nozzle,
the residual vibration suppression element of the at least one ejection pulse includes a first damping maintained element that maintains a constant electrical potential from an ending edge of the ejection element, and a first damping expansion element that starts changing an electrical potential from an ending edge of the first damping maintained element to expand the pressure chamber, and
when the natural vibration period of the ejection section is Tc,
the weight of the droplets to be continuously ejected from the nozzle when the drive signal is supplied to the drive element over the period corresponding to the two or more drive periods is corrected by adjusting at least one of a period of the first damping maintained element, an electrical potential change rate of the first damping expansion element, or an electrical potential change range of the first damping expansion element while a first time interval from a center time of a period of the ejection element to a center time of a period of the first damping expansion element is greater than 0.5Tc and less than 1.5Tc.

10. The driving method according to claim 9, wherein
when the weight of the droplets to be continuously ejected from the nozzle when the drive signal is supplied to the drive element over the period corresponding to the two or more of the drive periods is to be reduced, the first time interval is adjusted to a value closer to Tc than a value of the first time interval before the adjustment is, and
when the weight of the droplets to be continuously ejected from the nozzle when the drive signal is supplied to the drive element over the period corresponding to the two or more of the drive periods is to be increased, the first time interval is adjusted to a value more different from Tc than the value of the first time interval before the adjustment is.

11. A liquid ejecting apparatus comprising:
an ejection section including a nozzle from which a droplet is ejected, a pressure chamber communicating with the nozzle, and a drive element that is configured to be driven to change pressure applied to liquid in the pressure chamber according to a supplied drive signal, and
a drive signal generating circuit that is configured to generate the drive signal, wherein
the drive signal includes at least one ejection pulse in a drive period,
the at least one ejection pulse includes
an ejection waveform element that changes an electrical potential to change pressure applied to the liquid in the pressure chamber such that a droplet is ejected from the nozzle, and
a residual vibration suppression element that changes an electrical potential to reduce the change in the pressure applied to the liquid in the pressure chamber, the fluctuation remaining after the ejection of the droplet from the nozzle according to a natural vibration period of the ejection section, and
the residual vibration suppression element of the at least one ejection pulse is adjusted to correct a weight of droplets to be continuously ejected from the nozzle when the drive signal is supplied to the drive element over a period corresponding to two or more drive periods.
